(19) United States
(12) Patent Application Publication
(10) Pub. No.: US 2026/0212382 A1
(43) Pub. Date: Jul. 23, 2026

(54) SYSTEM AND METHOD TO DETERMINE/FORECAST DEMOGRAPHIC EXPENDITURE ON ONE OR MORE CATEGORIES OF GOODS AND/OR SERVICES

(71) Applicant: World Data Lab WDL GmbH, Vienna (AT)

(72) Inventors: Katharina Fenz, Vienna (AT); Homi Kharas, Chevy Chase, MD (US); Jesus Crespo Cuaresma, Vienna (AT); Wolfgang Fengler, Vienna (AT); Sourav Suman, Vienna (AT)

(73) Assignee: World Data Lab WDL GmbH, Vienna (AT)

(21) Appl. No.: 19/571,812

(22) Filed: Mar. 19, 2026

Related U.S. Application Data
(63) Continuation-in-part of application No. 18/826,861, filed on Sep. 6, 2024.

(51) Int. Cl. G06Q 30/0204

(52) U.S. Cl. CPC G06Q 30/0205

(57) ABSTRACT

Particular example embodiments described herein can provide for a system, an apparatus, and a method for collecting household income and expenditures data for a country, extending the household income and expenditures data for the country for each year in a period of time, collecting distribution demographic data for the country, extending the distribution demographic data for the country for each year in the period of time, and merging the household income and expenditures data and the distribution demographic data for the country to create a report determining and forecasting demographic expenditures on one or more categories of goods and/or services for the country.

### TECHNICAL FIELD

This disclosure relates in general to the field of computing and, more particularly, to a system, an apparatus, and a method to enable determining and forecasting of demographic expenditures on one or more categories of goods and/or services.

### BACKGROUND

Financial forecasting, also known as budget forecasting, is a process that helps countries predict financial metrics to plan for future success. Financial forecasting can help countries and businesses set goals, anticipate market conditions, and make informed decisions based on expected outcomes. In addition, financial forecasting can help set economic policies that promote financial stability, which is essential to increase economic well-being of a country and a business.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a system to help enable determining and forecasting demographic expenditures on one or more categories of goods and/or services, in accordance with an embodiment of the present disclosure;

FIG. 2 is a simplified block diagram of a particular implementation of total expenditure for demographic group engine to help enable determining and forecasting demographic expenditures on one or more categories of goods and/or services, in accordance with an embodiment of the present disclosure;

FIG. 3 is a simplified block diagram of a particular implementation of an income and expenditures per household engine to help enable determining and forecasting demographic expenditures on one or more categories of goods and/or services, in accordance with an embodiment of the present disclosure;

FIG. 4 is a simplified block diagram of a particular implementation of a distribution of income and expenditures engine to help enable determining and forecasting demographic expenditures on one or more categories of goods and/or services, in accordance with an embodiment of the present disclosure;

FIG. 5 is a simplified block diagram of a particular implementation of a merge household income and expenditures with distribution of income and expenditures engine to help enable determining and forecasting demographic expenditures on one or more categories of goods and/or services, in accordance with an embodiment of the present disclosure;

FIG. 6 is a simplified block diagram of a particular implementation of an expenditure on goods and/or services engine to help enable determining and forecasting demographic expenditures on one or more categories of goods and/or services, in accordance with an embodiment of the present disclosure;

FIG. 7 is a simplified block diagram of a particular implementation of a distribution of expenditure for demographic group on goods and/or services engine to help enable determining and forecasting demographic expenditures on one or more categories of goods and/or services, in accordance with an embodiment of the present disclosure;

FIG. 8 is a simplified block diagram of a particular implementation of a database to help enable determining and forecasting demographic expenditures on one or more categories of goods and/or services, in accordance with an embodiment of the present disclosure;

FIG. 9 is a simplified flowchart illustrating potential operations to help enable determining and forecasting demographic expenditures on one or more categories of goods and/or services, in accordance with an embodiment of the present disclosure;

FIG. 10 is a simplified flowchart illustrating potential operations to help enable determining and forecasting demographic expenditures on one or more categories of goods and/or services, in accordance with an embodiment of the present disclosure;

FIG. 11 is a simplified flowchart illustrating potential operations to help enable determining and forecasting demographic expenditures on one or more categories of goods and/or services, in accordance with an embodiment of the present disclosure;

FIG. 12 is a simplified flowchart illustrating potential operations to help enable determining and forecasting demographic expenditures on one or more categories of goods and/or services, in accordance with an embodiment of the present disclosure;

FIG. 13 is a simplified flowchart illustrating potential operations to help enable determining and forecasting demographic expenditures on one or more categories of goods and/or services, in accordance with an embodiment of the present disclosure;

FIG. 14 is a simplified flowchart illustrating potential operations to help enable determining and forecasting demographic expenditures on one or more categories of goods and/or services, in accordance with an embodiment of the present disclosure;

FIG. 15 is a simplified flowchart illustrating potential operations to help enable determining and forecasting demographic expenditures on one or more categories of goods and/or services, in accordance with an embodiment of the present disclosure;

FIG. 16 is a simplified flowchart illustrating potential operations to help enable determining and forecasting demographic expenditures on one or more categories of goods and/or services, in accordance with an embodiment of the present disclosure;

FIG. 17 is a simplified flowchart illustrating potential operations to help enable determining and forecasting future demographic expenditures on one or more categories of goods and/or services, in accordance with an embodiment of the present disclosure;

FIG. 18 is a simplified flowchart illustrating potential operations to validate data to help enable determining and forecasting demographic expenditures on one or more categories of goods and/or services, in accordance with an embodiment of the present disclosure;

FIG. 19 is a simplified flowchart illustrating potential operations to help enable determining and forecasting future demographic expenditures on one or more categories of goods and/or services, in accordance with an embodiment of the present disclosure;

FIG. 20 is a simplified flowchart illustrating potential operations to determine a total income and expenditures of households in a country for a predetermined time range to help enable determining and forecasting demographic expenditures on one or more categories of goods and/or services, in accordance with an embodiment of the present disclosure;

FIG. 21 is a simplified flowchart illustrating potential operations to determine a distribution of income and expenditures for households in continuous percentages steps to help enable determining and forecasting demographic expenditures on one or more categories of goods and/or services, in accordance with an embodiment of the present disclosure;

FIG. 22 is a simplified flowchart illustrating potential operations to determine a distribution of total income and expenditures for all years or a predetermined time range to help enable determining and forecasting demographic expenditures on one or more categories of goods and/or services, in accordance with an embodiment of the present disclosure;

FIG. 23 is a simplified flowchart illustrating potential operations to help ensure the distribution of household income and household expenditures in a country is relatively accurate to help enable determining and forecasting demographic expenditures on one or more categories of goods and/or services, in accordance with an embodiment of the present disclosure;

FIG. 24 is a simplified flowchart illustrating potential operations to parametrize income distributions and expenditure distributions and convert the distributions to a common currency to help enable determining and forecasting demographic expenditures on one or more categories of goods and/or services, in accordance with an embodiment of the present disclosure

FIG. 25 is a simplified flowchart illustrating potential operations to help enable abstracting demographic expenditures on one or more categories of goods and/or services, in accordance with an embodiment of the present disclosure;

FIG. 26 is a simplified flowchart illustrating potential operations to break the distribution of income and expenditures for a specific demographic into percentage steps to help enable determining and forecasting demographic expenditures on one or more categories of goods and/or services, in accordance with an embodiment of the present disclosure;

FIG. 27 is a simplified flowchart illustrating potential operations to merge the distribution of income and expenditures for a specific demographic with the distribution of total income and expenditures for households in a country to help enable determining and forecasting demographic expenditures on one or more categories of goods and/or services, in accordance with an embodiment of the present disclosure;

FIG. 28 is a simplified flowchart illustrating potential operations to generate a new report to help enable determining and forecasting demographic expenditures on one or more categories of goods and/or services, in accordance with an embodiment of the present disclosure;

FIG. 29 is a simplified flowchart illustrating potential operations to generate a report to help enable determining and forecasting demographic expenditures on one or more categories of goods and/or services, in accordance with an embodiment of the present disclosure;

FIG. 30 is a simplified block diagram illustrating example details of an example computer model inference and computer model training to help enable forecasting income and expenditures distributions, in accordance with an embodiment of the present disclosure; and

FIG. 31 is a simplified block diagram illustrating examples details of an example neural network architecture to enable forecasting income and expenditures distributions, in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems relating to enabling determining and forecasting demographic expenditures on one or more categories of goods and/or services, in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

In an illustrative example, a system, method, apparatus, means, etc. to help enable determining and forecasting demographic expenditures on one or more categories of goods and/or services can include a prediction and forecast electronic device. In an illustrative example, expenditure on goods and services data can be obtained from one or more data sources to help enable determining and forecasting demographic expenditures on one or more categories of goods and/or services. More specifically, the data (e.g., survey data) can be obtained from one or more of the International Monetary Fund (IMF), World Bank (WB), Organization for Economic Co-operation and Development (OECD), International Institute for Applied Systems Analysis (IIASA), or some other data source that includes expenditure on goods and services data. In some examples, the data is verified if possible.

To help enable determining and forecasting demographic expenditures on one or more categories of goods and/or services, the system can be configured to determine the share of total expenditures for the one or more categories of goods and/or services for a country. For example, using surveys and/or other data, the share of total expenditures for one or more categories of goods and/or services from the classification of individual consumption by purpose (COICOP) can be determined. For category groupings that do not follow a COICOP standard, (e.g., beauty products) definitions for the category groupings can be created and alternative datasets can be used to estimate the shares of spending for the category groupings that do not follow the COICOP standard. For example, household surveys, trade data (e.g., datasets from UN

Comtrade/Atlas of Economic Complexity), trade volume shares used to estimate share of spending on different products, and other datasets may be used to estimate the shares of spending for the category groupings that do not follow the COICOP standard. In addition, household budget surveys can be used to collect information about household expenditure of products that do not follow the COICOP standard.

Because the product level expenditure data in household budget surveys is available at a household level, to determine how much each individual in a household of a specific country is spending on different products, the marginal effect of change in household expenditure on different products is estimated by age groups and age weights can be determined to allocate total household expenditure on different product categories to individuals within a household. In some examples, households can be arranged by their per capita total expenditure. Each household can be assigned a survey weight, that is a measure of how many households in the country are similar to a specific household in the survey sample. Using the survey weight, the cumulative population share of each household can be determined. In a specific illustrative example, the cumulative population share of each household can be determined by multiplying the number of people in each household with the household weight, determining the cumulative sum population, and dividing by the total weighted population.

To harmonize the income and expenditures of different countries, the income and expenditure of each country can be broken down into percentage steps such that the income and expenditures of a certain percentage (the poorest five percent (5%)) is "X" percent. The income and expenditure of each country is estimated for a future predetermined time range (e.g., 50 years). In addition, the demographics of the country can be broken down into percentage steps such that a specific demographic represents "Y" percent of the population of the country (e.g. young men represent thirty-five percent (35%) of the poorest five percent (5%) in the country). By applying demographic distributions to predicted future income and expenditures, the system is able to forecast income and expenditures distributions for the country for specific demographics. Because the income distributions and expenditure distributions for the country are broken down into percentage steps, different countries can be compared with each other, even if the different countries rely on different currencies.

If spending distributions for each country is available, households can be assigned to different spending groups. For example, if the bottom 20% of households in a country are in the spending group "Vulnerable and Poor", the bottom 20% of the households (based on cumulative population share) can be assigned to the group "Vulnerable and Poor". For example, if the income distributions and expenditure distributions for the country are broken down into percentage steps (as described above), after the share of total expenditures for the one or more categories of goods and/or services for a country is acquired, the category or subcategory expenditure of a demographic group in a given country and year can be estimated and forecasted.

### Example Systems, Apparatuses, and Methods

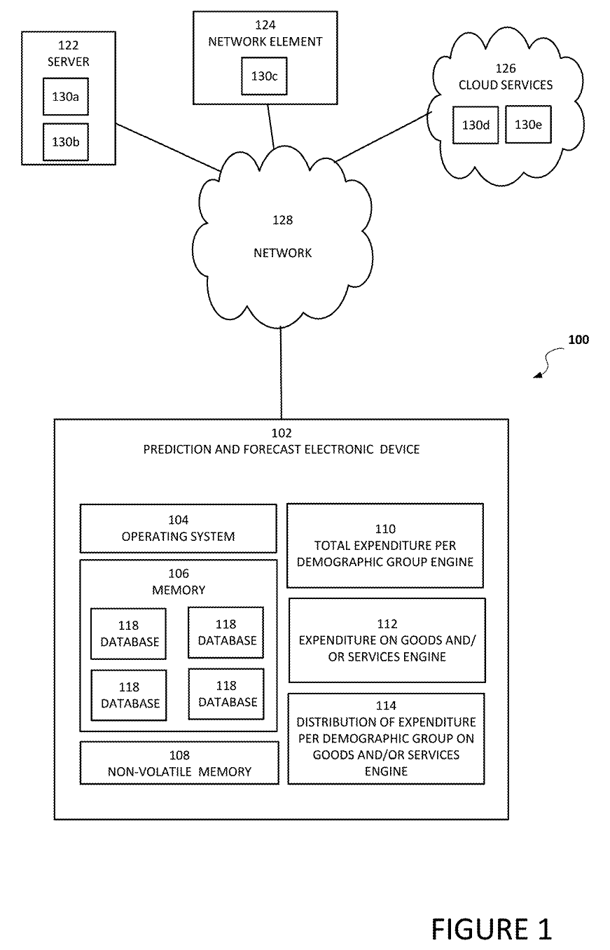

FIG. 1 is simplified block diagram of a particular non-limiting system 100 to enable determining and forecasting demographic expenditures on one or more categories of goods and/or services. The system 100 can include a prediction and forecast electronic device 102. The prediction and forecast electronic device 102 can include an operating system 104, memory 106, non-volatile memory 108, a total expenditure per demographic group engine 110, an expenditure on goods and/or services engine 112, and a distribution of expenditure per demographic group on goods and/or services engine 114. The memory can include one or more databases 118.

In an illustrative example, the prediction and forecast electronic device 102 can be in communication with one or more servers 122, one or more network elements 124, and/or cloud services 126 using network 128. Each of the server 122, the network element 124, and cloud services 126 can include one or more data sources 130. For example, as illustrated in FIG. 1, the server 122 includes data sources 130a and 130b, the network element includes data source 130c, and cloud services includes data sources 130d and 130e. The data sources 130 include data that can be used by the prediction and forecast electronic device 102 to help enable determining and forecasting demographic expenditures on one or more categories of goods and/or services. The data from the data sources 130 can be stored in the one or more databases 118.

In an illustrative example, the prediction and forecast electronic device 102 and/or the total expenditure per demographic group engine 110 can communicate with one or more of the server 122, the network element 124, and/or cloud services 126 using network 128 to obtain one or more data sources 130 that are related the income and expenditure distributions of a country as well as to the GDP growth rate of the country. To help determine future household expenditure rates, the household expenditure rate for the country is allowed to grow with the GDP growth rate of the country. In addition, the prediction and forecast electronic device 102 and/or the total expenditure per demographic group engine 110 can communicate with one or more of the server 122, the network element 124, and cloud services 126 to obtain one or more data sources 130 that are related to national accounts data and determine the savings rate for the country. The data from the data sources 130 can be stored in the one or more databases 118.

The total expenditure per demographic group engine 110 can create continuous income and expenditures distributions based off of the forecasted expenditure and the savings rate of the country. In some examples, the income and expenditures are broken down into one percent (1%) steps such that the poorest one percent (1%) income and expenditures is determined (for example, the poorest group in a country has 0.2 of the total expenditures of the country) all the way up to one-hundred percent (100%). The one percent (1%) steps provide data at all percentages from one percent (1%) to one hundred percent (100%). Note that the data from the one or more data sources 130 typically does not include all the percentages. By breaking down the income and expenditures into one percent (1%) steps, the income and expenditures for a specific country can be homogenized or harmonized to allow for comparison with other countries.

In addition, the prediction and forecast electronic device 102 and/or the total expenditure per demographic group engine 110 can communicate with one or more of the server 122, the network element 124, and cloud services 126 to obtain one or more data sources 130 that are related to demographic information of people in the country. In some examples, the data is survey data related to demographic information of people in the country. The national distribution of income and expenditures of people in the country is broken down into percentage steps (e.g., five percent (5%) steps) to identify the expenditures or income levels of the poorest five percent (5%), the poorest ten percent (10%), etc. Then the people in the survey are grouped into one of the percentage steps. Each person's weight (the number of people in the population of the country that the person represents) in the survey is aggregated to allow each person in the survey to represent a portion of the population of the country with the same demographics. In some examples, the weight of each person is aggregate by the percentages, the brackets in the distribution, as well as by the demographics represented by the survey. For each demographic group, the share of the demographic group in each percentage step is determined. For example, for each demographic group, the system determines what share of that group is in the poorest five percent (5%), the next five percent (5%) and so on (e.g., six percent (6%) of a specific demographic group is in a specified five percent (5%) income and expenditures step). By determining the share of the demographic group in each income and expenditures percentage step, the demographic data can be compared with the national data and the forecasted income and expenditures of the national population that was broken into one percent (1%) steps can be used to forecast income and expenditures distributions for a specific demographic of people in a country.

In an illustrative example, the prediction and forecast electronic device 102 and/or the expenditure on goods and/or services engine 112 can communicate with one or more of the server 122, the network element 124, and/or cloud services 126 to acquire, from the one or more data sources 130, expenditure on goods and services data for one or more categories of goods and/or services. The data sources 130 include data that can be used by the expenditure on goods and/or services engine 112 to help enable a determination of the share of total expenditures for one or more categories of goods and/or services for a country. The data from the data sources 130 can be stored in the one or more databases 118. In a specific illustrative example, a portion of the total spending for the demographic groups is allocated to one or more Level 1 categories from the COICOP classification.

The 1999 COICOP classification has twelve (12) Level 1 categories and the 2018 COICOP has classification has thirteen (13) Level 1 categories. The 1999 COICOP breaks down the Level 1 categories into Level 2 sub categories, and the Level 2 subcategories are broken down into Level 3 subcategories. The 2018 COICOP breaks down the Level 1 categories (or Divisions with two-digit codes) into Level 2 sub categories (or Groups with three-digit codes), the Level 2 subcategories are broken down into Level 3 subcategories (or Classes with four-digit codes), and the Level 3 subcategories are broken down into Level 4 subcategories (or subclasses with five- digit codes). Many of the expenditure on goods and services datasets either only provide expenditure information for COICOP categories or have product level expenditures already labeled with their corresponding COICOP code. However, other classification schemes may be used.

To provide granularity, the total spending for a demographic group is allocated to the Level 2 subcategories of the Level 1 category from the COICOP classification, where the spending on the Level 2 categories can be added together to equal the total spending for the demographic group allocated to the Level 1 category. In addition, to provide even further granularity, the total spending for the demographic group is allocated to Level 3 subcategories of each of the Level 2 subcategories of the Level 1 category from the COICOP classification, where the spending on the Level 3 subcategories can be added together to equal the total spending for the demographic group allocated to the Level 2 subcategory. In another illustrative example, a portion of the total spending for the demographic groups is allocated to one or more categories based on survey results and assigned a COICOP classification.

For category groupings that do not follow a COICOP standard, (e.g., beauty products category, subcategories such as hair care, skin care, etc.) definitions for the category groupings can be created and alternative datasets can be used to estimate the shares of spending for the category groupings. For example, household surveys trade data (e.g., datasets from UN Comtrade/Atlas of Economic Complexity), trade volume shares to estimate share of spending on different products, and other datasets may be used to estimate the shares of spending for the category groupings that do not follow the COICOP standard. In addition, household budget surveys can be used to collect information about household expenditure of different products that have a COICOP classification and for products that do not follow a COICOP standard and do not have the COICOP classification.

In most surveys, there are different recall periods for different products, for example a questionnaire might ask "How much did you spend on bread in the last one week?" or "How much did you spend on clothing in the last 3 months?" or "How much did you spend on furniture in the last one year?", depending on the likelihood of the frequency of purchase of different products and to avoid any recall bias (people might not remember how much they spent on bread in the last 3 months, but can estimate how much they spent on bread for 1 week). All of these spending values can be annualized (for example, multiplying weekly spending values by fifty-two (52)) to obtain annual household expenditure for different products for all households. Because the product level expenditure data in household budget surveys is available at a household level, to determine how much each individual in a household of a specific country is spending on different products, the marginal effect of change in household expenditure on different products is estimated by age groups, and age weights can be determined to allocate total household expenditure on different product categories to individuals within a household. The system does not simply assign an equal share to each individual in a household because that can lead to some confusing results (for example if a household consisting of two parents and one child under ten years old spends three hundred dollars ($300) annually alcohol, if everyone in the household was assigned an equal share, even the child under ten years old would be assigned some spending/consumption on alcohol). In some examples, households can be arranged by their per capita total expenditure. Each household can be assigned a survey weight that is essentially a measure of how many households in the country are similar to the specific household in the survey sample. Using the survey weight, the cumulative population share of each household can be determined. In a specific illustrative example, the cumulative population share of each household can be determined by multiplying the number of people in each household with the household weight, determining the cumulative sum population, and dividing by the total weighted population.

The distribution of expenditure per demographic group on goods and/or services engine 114 can be configured to use the income and expenditures distributions for a specific demographic of people in a country determined by the total expenditure per demographic group engine 110 and the share of total expenditures for one or more categories of goods and/or services for a country determined by the expenditure on goods and/or services engine 112 to determine the category or subcategory expenditure of a demographic group in a given country and year.

In some examples, income and expenditures data from one or more data sources is harmonized in order to be able to compare forecasted income and expenditures between countries. To harmonize the income and expenditures of different countries, the income and expenditure of each country can be broken down into percentage steps such that the income and expenditures of a certain percentage (the poorest five percent (5%)) is "X" percent. The income and expenditure of each country is estimated for a future predetermined time range (e.g., fifty (50) years).

In addition, the demographics of the country can be broken down into percentage steps such that a specific demographic represents "Y" percent of the population of the country (e.g. young men represent thirty-five percent (35%) of the poorest five percent (5%) in the country). By applying demographic distributions to predicted future income and expenditures, the system is able to forecast income and expenditures distributions for the country for specific demographics. Because the income distributions and expenditure distributions for the country are broken down into percentage steps, different countries can be compared with each other, even if the different countries rely on different currencies.

If spending distributions for each country is available, households can be assigned to different spending groups. For example, if the bottom twenty percent (20%) of households in a country are in the spending group "Vulnerable and Poor," the bottom twenty percent (20%) of the households (based on cumulative population share) can be assigned to the group "Vulnerable and Poor." For example, if the income distributions and expenditure distributions for the country are broken down into percentage steps (as described above), after the share of total expenditures for the one or more categories of goods and/or services for a country is acquired, the category or subcategory expenditure of a demographic group in a given country and year can be estimated and forecasted.

It is to be understood that other embodiments and implementations may be utilized, and structural changes may be made without departing from the scope of the present disclosure. Substantial flexibility is provided by the system and method in that any suitable arrangements and configuration may be provided without departing from the teachings of the present disclosure. For purposes of illustrating certain example techniques to enable determining and forecasting demographic expenditures on one or more categories of goods and/or services, the following foundational information may be viewed as a basis from which the present disclosure may be properly explained.

While it is crucial to know the overall consumer spending power, the key to successful market entry lies in understanding the specific demand for product categories relevant to a business that may enter the market. For example, wealthier households generally allocate a smaller portion of their expenditure to food compared to less affluent ones. More specifically, despite the USA's overall higher national expenditure, China, with a lower national expenditure as compared to the USA, surpasses the USA in spending on vegetables.

In addition, financial forecasting is predicting a country's financial future by examining historical performance data. The financial forecast can be used to help predict the overall health and stability of a country including national accounts, inflation, unemployment rates, balance of payments, fiscal indicators, and other health and stability indicators. The financial forecast can also be used by businesses to help determine new market opportunities. Many businesses are eager to develop into emerging global markets, but are unfamiliar with how to accurately quantify the potential opportunity in these regions. One way to perform financial forecasting of a country is to determine the income and expenditures distributions of the country. However, currently there is not an accurate system, apparatus, or method to help enable determining and forecasting demographic expenditures on one or more categories of goods and/or services of a country. What is needed is a system, an apparatus, and a method to help enable determining and forecasting demographic expenditures on one or more categories of goods and/or services of a country.

A system, method, apparatus, means, etc. to help enable determining and forecasting demographic expenditures on one or more categories of goods and/or services of a country can help resolve these issues (and others). In an example, a system and method can include a prediction and forecast electronic device (the prediction and forecast electronic device 102). The prediction and forecast electronic device can include a total expenditure per demographic group engine (e.g., the total expenditure per demographic group engine 110), an expenditure on goods and/or services engine (e.g., the expenditure on goods and/or services engine 112), and a distribution of expenditure per demographic group on goods and/or services engine (e.g., the distribution of expenditure per demographic group on goods and/or services engine 114). The total expenditure per demographic group engine can be configured to help determine the income and expenditure distributions of a country as well as to the GDP growth rate of the country. The expenditure on goods and/or services engine can be configured to help determine the expenditure of the country on goods and services data for one or more categories of goods and/or services. The distribution of expenditure per demographic group on goods and/or services engine can be configured to use the income and expenditures distributions for a specific demographic of people in the country determined by the total expenditure per demographic group engine and the share of total expenditures for one or more categories of goods and/or services for the country determined by the expenditure on goods and/or services engine to determine the category or subcategory expenditure of a demographic group in a given country for a specific year.

Determining the share of total expenditures for one or more categories of goods and/or services for a country can enable businesses to forecast spending across over one- hundred (100) standardized product categories as well as many more categories that can be broken out on demand (categories that are not in the standardized product categories). These categories can then be further segmented by key demographics. A further dimension can be added by breaking down data with greater geographic depth within over six thousand (6,000) cities with a population over fifty thousand (50,000), across the globe. More specifically, similar to determining demographic expenditures on one or more categories of goods and/or services at a country level as described herein, using household surveys and data on a spatial distribution of a subnational region population and spending from various sources within each subnational region (e.g., WorldPop for population, state GDP accounts, and/or other sources for spending), the share of total expenditures for one or more categories of goods and/or services for a subnational region can be determined and segmented by key demographics to help determine demographic expenditures on one or more categories of goods and/or services for the subnational region. Armed with this data, companies can strategically decide which markets to enter and on which demographic groups to focus, ensuring informed and effective market entry strategies as well as accurate forecasting modeling based on the latest expenditure information.

Estimating and forecasting expenditure by demographic groups is a challenge in itself. The system can use one or more country level expenditure models as a baseline and then go even further to understand how spending patterns differ not only by country, year, and demographic groups but within over one-hundred (100) product categories as well. In an illustrative example, the expenditure on goods and/or services engine can be configured to estimate the allocation of a demographic group's total expenditure in a country and year to a category or subcategory. The benefit of this approach is that a demographic group's estimated expenditure on all subcategories of a given split adds up to the demographic group's estimated expenditure on the parent category of that split so, all the expenditures for all the categories and subcategories sum upwards and downwards.

In some examples, the system classifies products based on the 1999 COICOP developed by the United Nations Statistics Division. The COICOP was developed by the United Nations Statistics Division to provide a framework for grouping household consumption expenditures on goods and services within homogeneous categories based on the particular purpose that those goods and services are considered to fulfil. The COICOP is part of a set of classifications of expenditures according to purpose, also known as "functional" classifications, which have been part of the System of National Accounts (SNA) since 1968. The SNA is the internationally agreed standard set of recommendations on how to compile measurements of economic activity. The SNA describes a coherent, consistent and integrated set of macroeconomic accounts in the context of a set of internationally agreed concepts, definitions, classifications, and accounting rules. The 1999 COICOP classification has twelve (12) Level 1 categories and over one-hundred (100) Level 3 subcategories.

The United Nations Statistics Division released a new COICOP in 2018 to add more detailed subclasses, reflect changes in goods and services, especially changes related to the digital economy and new technologies, improve links to other classifications, such as national accounts and price statistics, addresses emerging statistical needs, and other changes and additions. The UN Statistical Commission endorsed the revised COICOP 2018 in March 2018, recommending its adoption by countries as a statistical standard. COICOP 2018 provides greater detail and reflects significant shifts in goods and services and aims for better linkages with other COICOP code classifications. However, many countries still report and classify products based on the 1999 COICOP.

To help determine the share of total expenditures for one or more categories of goods and/or services for a country, the system can collect the share of expenditures out of the Level 1 categories of the COICOP, over thirty (30) covariates (sometimes referred to as predictors) mainly consisting of socioeconomic and demographic indicators, Consumer Price Index (CPI) weights, household expenditure data, national household expenditure survey results, and other data to help determine the share of total expenditures for one or more categories of goods and/or services for a country.

The data for the share of expenditures out of the Level 1 categories of the COICOP, can be collected from national account, CPI weights, household budget surveys, ICPI, WDP, World Development Indicators, Wittgenstein, the IMF, and other sources for the share of expenditures out of the Level 1 categories of the COICOP. For category groupings that do not follow a COICOP standard, like the subcategories for beauty, definitions for the category groupings that do not follow a COICOP standard can be created and alternative datasets can be used to estimate the shares of spending. More specifically, household surveys with product level information for the category groupings that do not follow a COICOP standard can be used to create groups for the category groupings that do not follow a COICOP standard. In addition, other datasets like trade data (datasets from UN Comtrade / Atlas of Economic Complexity) and trade volume shares can be used to estimate share of spending on different products. For example, from the trade datasets, data on exports and imports of different products in different countries can be obtained. From the obtained data from trade datasets an estimate of domestic consumption for those products can be determined. For example, the system can determine how much a country spends on fish and seafood and data from imports and exports of different kinds of fish can be used to get an estimate of consumer spending on different subcategories of fish.

In some examples, the over thirty (30) covariates are collected from various sources including WDP, World Development Indicators, Wittgenstein, the IMF, and other sources of covariate data. The covariates can include, but are not limited to, per capita spending (2021 PPP), female share, consumer class share, old dependency ratio (the ratio of the number of people above sixty-five (65) as compared to the working age population (e.g., fifteen to sixty-five (15-65)), young dependency ratio (the ratio of the number of people under fifteen (15) as compared to the working age population (e.g., fifteen to sixty-five (15-65)), mean years of schooling, mean childbearing age, net migration, fertility rate, life expectancy (male), life expectancy (female), percent with secondary education, consumption share of GDP, exports share of GDP, imports share of GDP, female employment ratio, employment rate, gender parity index, high tech exports (% of total exports), ores and metals exports (% of total exports), logistics Index, net barter terms of trade index, arable land (% of total land), urbanization rate, capital formation share of GDP, savings share of GDP, government expenditure share of GDP, current account share of GDP, real GDP growth, inflation rate, per capita GDP (2021 PPP), regions (e.g., seven (7) world regions), and majority religions (e.g., eight (8) religions). The covariates are at the country-year level and cover 183 countries for the years 2010 to 2034.

The national accounts data is collected from each country's national statistical office's website. While some centralized databases exist, for example from United Nations Statistics Division, Eurostat, OECD, etc. which are easier to collect and work with, the downside of using a centralized database are that the centralized databases do not cover all countries, are not always up-to-date, and are less granular. Therefore, in some examples, the datasets collected directly from each country's national statistical office are prioritized over centralized databases. In some examples, the breakdown of household consumption expenditure into different product categories from the national accounts can be used as a source of training data for the product categories model by determining the share of spending on different product categories.

The CPI weights can be collected from country NSO websites, the IMF, and other sources of CPI weights. The CPI is an index for the general price level of the goods and services bought by households. Because different products can have different dynamics of price changes, statistical agencies collect information on expenditure shares of different products consumed by the households and use the CPI as weights to determine a weighted average of price levels of different products. The CPI weights reflect the relative importance of the goods and services in the Level 1 categories of the COICOP as measured by their shares in the total consumption of households from the Household Budget Surveys (HBS). The IMF CPI weights only provide shares for COICOP Level 1 categories. Additional CPI weights for COICOP subcategories (Level 2, Level 3, etc.) can be collected from national statistic offices, OECD national accounts as well as from Eurostat. The granularity of these weights varies from Level 1 categories of the COICOP all the way to level four categories of the COICOP. Some of these additional CPI weights may already be labelled with COICOP classifications while others may need to be manually assigned COICOP classifications. The CPI weights are harmonized for all countries to follow the COICOP standard at COICOP level 1. The CPI weights collected from different country national statistic offices may or may not follow the COICOP standard and may or may not be more granular (for most cases, they go down to Level 2 or Level 3 CPI weights, but there are also cases where some only report the Level 1 CPI weights). The CPI weights that do not follow the COICOP standard and only list the product names and their corresponding weights can be classified to fit into the COICOP structure.

The household expenditure data can be obtained from the WB International Comparison Program (ICP) or other sources of household expenditure data. The WB ICP is one of the largest statistical initiatives in the world and provides household expenditure data on one hundred and seventy-six (176) participating economies in 2017 and one hundred and seventy- nine (179) economies in 2011. The granularity of ICP data varies by category of the COICOP. For both years the WB ICP provides expenditure information on complete Level 1COICOP categories as well as Level 2 COICOP categories for food and beverage, alcohol and tobacco, and transportation. The WB ICP further provides granularity for food Level 3 COICOP categories. To maintain consistency, the Level 1 WB ICP shares are first rescaled to better match the IMF CPI weights. This rescaling step is only done for Level 1 COICOP categories and not for Level 2 COICOP categories and Level 3 COICOP categories. This is because the WB ICP data for Level 1 COICOP categories is the only level of the COICOP categories at which there is sufficient overlap with the IMF CPI weights. For Level 2 COICOP transportation categories, only two of the three transportation subcategories of the COICOP are provided by the WB ICP. The third transportation subcategory of the COICOP is computed by subtracting the sum of the two transportation subcategories of the COICOP from the parent Level 1 COICOP transportation category for each country and year in the WB ICP.

In addition, the system can also compute the expenditure shares from household expenditures surveys (e.g., forty (40) household expenditure surveys) that are harmonized. The expenditure surveys are by far the most granular data and the only data with COICOP category level expenditure at the demographic level. All surveys represent the expenditure of a household in a particular country and year and provide expenditure information at the product level. This is often measured through respondents logging their household expenditures in weekly, monthly and yearly diaries.

To harmonize the household expenditures surveys, the annual expenditure of each household is determined at the product level. The information about the individuals living in each household can be used to obtain product expenditure at the individual level with each individual in a household being assigned an equal share of the total household expenditure. Individuals in a country year are then ranked by their total annual expenditure and assigned a weighted cumulative share of total expenditure. The cumulative share is then used to match individuals in each survey to their corresponding World Data Pro expenditure groups.

Next products are assigned a corresponding COICOP code using a natural language processing model. Various models, including but not limited to naive bayes, support vector machines, random forests and ensemble methods, etc. can be trained on surveys that are already assigned COICOP codes and select the best model using cross validation. Any remaining products that were assigned an incorrect COICOP code can be manually corrected. Using the harmonized and labeled surveys, both the national as well as demographic share of expenditure on a particular COICOP category or subcategory can be determined.

Even for Level 1 COICOP categories, the system may not have data on shares of spending on different categories and, in some examples, a computer model can be used to collect data from similar countries and determine the shares of spending on different categories in the countries where there is not any data on the shares of spending on different categories. In some examples, the computer model can analyze the data recursively on each level of the COICOP. For Level 1 COICOP categories, the system may have Level 1 COICOP category data for a plurality of countries and may not have Level 1 COICOP category data for one or more countries (e.g., may have Level 1 COICOP category data for one hundred and sixty (160) countries out of one hundred and eighty (180) or one hundred and ninety (190) countries). For the countries where there is no data for the Level 1 COICOP categories, the computer model can use the data from one or more of the countries with Level 1 COICOP category data to fill in the missing data and based on income level and other co variants, predict the share of spending on the missing Level 1 COICOP categories. Similarly for Level 2 COICOP categories, there is a smaller set of countries that the system will have data and mostly depends on the categories. For food COICOP categories, there are some countries that have Level 2 COICOP food category data such as restaurants or non-alcoholic drinks. To determine the missing data for Level 2 COICOP food categories, the process in the same where the system can take data from the countries (e.g., one hundred (100) countries) where there is Level 2 COICOP category data and the computer model can determine the missing data using urbanization rates, per capita spending, etc. to identify similar countries and determine the shares of spending in the categories where there is missing data. In a specific example, a country may spend ninety percent (90%) on food products and the remaining ten percent (10%) would be on non-alcoholic beverages. To determine missing data at the national level, in some examples, the system can use the computer model to find a similar country or countries and then allocate a similar category share using the category data from the similar country or countries.

Using the computer model to fill in the gap from any COICOP categories where there is missing data, the expenditures at the national level per one or more COICOP categories of goods and/or services for every single country can be determined for every year where data is available (e.g., from the year 2000 until the current year where data is available). For future forecasts (e.g., up to the year 2050) of the expenditures at the national level per one or more COICOP categories of goods and/or services, countries can be grouped based on different demographic, geographic, and economic variables such as forecasting spending, medium age, distribution, etc. The system can predict how the variables will change in the future and the dynamics of how the variables are predicted to change can be used to determine how the spending on different categories will change. For example, a common spending characteristic is that as countries get richer, they spend less on food and more on other goods and services and food spending decreases.

The category or subcategory expenditure of a demographic group in a given country and year can be estimated and forecasted. This is done by first breaking national expenditure of the country into Level 1 COICOP categories and then demographic expenditure by the Level 1 COICOP categories. The national expenditure by Level 1 COICOP categories can be broken down into Level 2 COICOP categories and so on. The reason both the national expenditures and demographic expenditures are used is because the raw data at the national level can be more expansive and accurate than the raw data at the demographic level. In some examples, a technique called iterative proportional fitting (IPF) can be performed at each level of the national and demographic expenditures to rescale the demographic category expenditures to add up to the national category expenditures.

In some examples, a separate model is used to estimate missing data from each level of category and subcategories of the COICOP. For example, the model used to estimate a Level 2 COICOP subcategory, 1_x, will be different from the one used to estimate a Level 3 COICOP subcategory, 1 _1_x, where 1_x estimates the Level 2 COICOP subcategory (e.g., the share of food versus non-alcoholic beverages out of food and non-alcoholic beverages) and 1_1_x estimates the Level 3 COICOP subcategory or share of Level 3 COICOP subcategories in food out of the Level 2 COICOP subcategory food expenditure. In each of these models, the observations are countries in a particular year, the response is the share of expenditure of the subcategory out of the parent Level 1 COICOP category (collected from the IMF CPI weights, Scrapped CPI weights, World Bank ICP, national household expenditure surveys, etc.) and the predictors are the same set of covariates. In a specific illustrative example, where expenditure shares data is available for the same observations from multiple sources, the expenditure shares can be chosen in the order of the IMF being the most preferred and the national household expenditure surveys being the least preferred.

Using the expenditure shares in the raw data, machine learning models (e.g., lasso, ridge Bayesian model averaging, Dirichlet, or other machine learning models) can be trained to determine category or subcategory expenditure of a demographic group. For each machine learning model, a logit link can be used to help ensure the estimated response (9) will always be a share or element of the set (0,1) or f E (0, 1). More specifically, the response, y E (0, 1) is transformed using the logit function y = In (y/(1-y)) E R.

If the raw share for a particular y subcategory in a split is equal to zero or one, a small constant is added or subtracted to ensure y E (0, 1). The models are then trained on y and transform the estimates y E R back to shares using the inverse of the logit function y = 1/(1+e-y) E (0, 1). The best machine learning models can be selected using a leave one country out cross validation process with a mean absolute error as the metric for evaluation.

The estimates of the model are then grouped by country and year and rescaled to ensure all the subcategories of a given split add up to the parent category. For all countries that have raw shares available for all the subcategories in a split, the model estimates are replaced with the raw shares. Missing years for those countries are then determined using the year-to-year growth rates of the model estimates for that country.

Similarly to using the computer model to fill in the gap from any COICOP categories where there is missing data, for each level of the demographic model, a separate model is used for each category or subcategory split. However, each observation in the demographic model represents a demographic group in a given country and year. The system can break the data down into age groups (e.g., five-year age groups) and spending groups (e.g., five spending groups) for each country year, resulting in distinct demographic groups. More specifically, an illustrative example of five (5) year age groups and five (5) spending groups would result in twenty-five (25) distinct demographic groups. The training and model selection method is similar to the training and model selection method used for the computer model to fill in the gap from any COICOP categories where there is missing data, as described above. The main difference is that the demographic model has two additional covariates, the per capita expenditure of the demographic group and a dummy variable for the age group of the demographic group. Additionally estimates in the demographic model are not replaced with raw data after estimation. The covariates can include, but are not limited to, per capita spending (2021 PPP), female share, consumer class share, old dependency ratio (the ratio of the number of people above sixty-five (65) as compared to the working age population (e.g., fifteen to sixty-five (15-65)), young dependency ratio (the ratio of the number of people under fifteen (15) as compared to the working age population (e.g., fifteen to sixty-five (15-65)), mean years of schooling, mean childbearing age, net migration, fertility rate, life expectancy (male), life expectancy (female), percent with secondary education, consumption share of GDP, exports share of GDP, imports share of GDP, female employment ratio, employment rate, gender parity index, high tech exports (% of total exports), ores and metals exports (% of total exports), logistics Index, net barter terms of trade index, arable land (% of total land), urbanization rate, capital formation share of GDP, savings share of GDP, government expenditure share of GDP, current account share of GDP, real GDP growth, inflation rate, per capita GDP (2021 PPP), regions (e.g., seven (7) world regions), and majority religions (e.g., eight (8) religions). The resulting estimates of the demographic breakdown of expenditures results in the share of a demographic group's expenditure on a COICOP subcategory out of the demographic group's expenditure on the parent COICOP category. For example, one estimate could be the share of expenditure on meat out of food for sixty-six and over (65+) year olds in the one hundred and twenty and over (120+) spending group in the USA in the year 2024.

At each COICOP classification level, a factor estimation can be used to perform iterative proportional fitting where, at each COICOP level, the factor estimation makes minor adjustments to the demographic groups expenditures on a specific COICOP category to ensure that all the demographic groups add up to the national expenditure on that specific COICOP category while also ensuring that all COICOP subgroup category expenditures for a demographic group add up the demographic group's expenditure on the parent COICOP category.

Projections can be determined within both the national and demographic expenditures using projected values for the covariates that are projected. The final projections can then be determined from an iterative proportional fitting (IPF) step at each COICOP level. One issue with this method is that as countries get richer, spending patterns for the whole world converge to look similar to the USA. To account for this, an alternative method to project the future category expenditures for a demographic group can use the demographic category expenditure shares for 2023 as an anchor year and fix the future category expenditures for a demographic group across time. Using this method, a country's spending patterns are only driven by demographic changes in that country. In other words, the assumption is made that the spending patterns of a demographic group do not change, but the amount of people in a demographic group may change. In an illustrative example, an assumption can be made that rich young people in India will have the same spending patterns in year 2030 as in year 2023, but that the amount of rich young people in India and their total expenditure per capita might change.

The challenge in the categories model is that the available data is limited. Although there can be good coverage of raw data for national Level 1 category COICOP demographic shares as well as some Level 2 subcategory COICOP demographic shares and even some Level 3 subcategory COICOP demographic shares such as food, for most Level 2 subcategory COICOP demographic shares and especially Level 3 subcategory COICOP demographic shares, national level data is typically available for less than approximately sixty (60) countries. However, the main issue is the limit of demographic data with national category expenditure for a specific country. Currently there is only access to a maximum of forty (40) national expenditure surveys for all demographic level COICOP category expenditure estimates. Although the surveys generally cover a wide variety of products, for some Level 3 COICOP subgroups, only demographics data available from a handful of surveys (sometimes less than ten (10)) are available to determine global estimates.

Another challenge is that there can to be a significant discrepancy in raw shares across data sources. This is especially the case for Level 1 COICOP Category 4, housing, where the inclusion of "imputed rents" in national accounts aggregates make the shares significantly higher than those estimated from household budget surveys, which typically do not measure "imputed rents." The IMF housing shares are on average significantly higher than those in the surveys or other sources. In some examples, any of the surveys that have data on at least two of the COICOP subcategories of a given split are included where a share of zero is added to the missing COICOP subcategories for that survey. However, unless the expenditure for the missing COICOP subcategories in those country-years was zero or close to zero for those subcategories, the estimates for countries with similar predictors may be biased downward and estimates for the existing subcategories will likely be upward bias.

Once the expenditures at the national level per one or more COICOP categories of goods and/or services of every country for every year from a given range (e.g., year 2000 to year 2050), the expenditures at the national level per one or more COICOP categories of goods and/or services can be broken down by age and spending groups using the core spending data and spending by age across spending groups. For example, the total national spending on food for a given country can be broken down by age across spending groups and allocated into different spending groups. For example, for Austria, in total, if the country spends around fifteen percent (15%) of the total national expenditure on food, the system can determine how much poor people age forty-five to sixty-five (45-65) in Austria spend on food. Using household surveys spending distributions by different kinds of spending levels of different households can be determined and using different information about the individuals in the household and the system can estimate how much of food consumption is being spent by the adults in a household verses children in the household. The shares for different demographic groups are obtained from surveys.

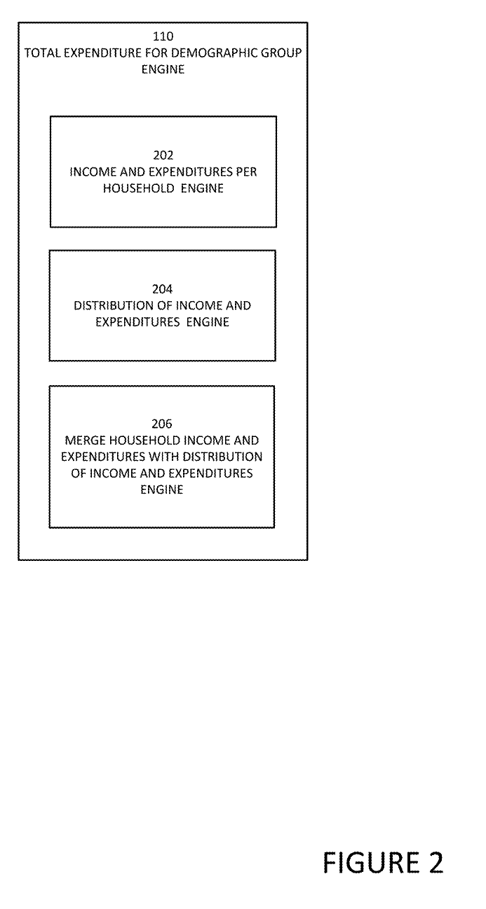

In some examples, the total expenditure per demographic group engine can include an income and expenditure per household engine (e.g., an income and expenditure per household engine 202, illustrated in FIG. 2), a distribution of income and expenditures engine (e.g., a distribution of income and expenditures engine 204, illustrated in FIG. 2), and a merger engine (e.g., a merger household income and expenditures with distribution of income and expenditures engine 206, illustrated in FIG. 2). In an illustrative example, the total expenditure per demographic group engine can obtain data from one or more data sources (e.g., the one or more data sources 130) to help enable determining and forecasting demographic expenditures on one or more categories of goods and/or services.

More specifically, in an example, the prediction and forecast electronic device can obtain data from one or more of the International Monetary Fund (IMF), World Bank (WB), Organization for Economic Co-operation and Development (OECD), International Institute for Applied Systems Analysis (IIASA), or some other data source. Once the data from one or more data sources is received, the data is formatted and verified if possible. In one example, if the data is obtained from more than one source, each data set is compared to the other data sets to check for discrepancies. In some cases, multiple data sets can be averaged to generate one data set.

After the data is obtained, the data is used to generate GDP growth rates for the country. To predict household expenditures in the country, the total income distributions and total expenditure distributions of the country are determined and are increased in line with the growth rate of GDP. In some examples, a savings rate is determined and applied to estimate incomes based on expenditure. The income distributions and expenditure distributions of the country are broken down into percentage increments. In a specific example, income distributions and expenditure distributions of the country are brought into 0.1% increments (the poorest 0.1% of the population have x% of total income, the poorest 0.2% have y% of total income, etc.).

For countries with missing income distributions or expenditure distributions, regressions can be used to predict or forecast missing income distributions or expenditure distributions. For example, income distributions for countries with no income distributions data are predicted or forecasted using expenditure distributions data. For countries with no expenditure distributions data, the expenditure distributions are predicted or forecasted using income distributions data. For countries with no income distributions data and no expenditure distributions data, another country with similar socioeconomics is used to predict or forecast the income distributions and the expenditure distributions for the country. In some examples, a machine learning model is trained to use socioeconomic data to predict or forecast a country's total household income and expenditure and the trained machine learning model can be used to predict or forecast missing household income distributions and expenditure distributions. Distributions of household income and expenditures are adjusted such that the sum of household income and expenditure from the distribution equals the total income and expenditure of the country. Income distributions and expenditure distributions for years between observations are interpolated and income distributions and expenditure distributions are kept constant for future years after the last observation.

Once determined, the income distributions and expenditure distributions are abstracted in a compact way using parameters. For example, linear regressions can be used to estimate three parameters that describe each income distribution and expenditure distribution for the country. The income distributions and expenditure distributions are converted into a common monetary increment (e.g., one-dollar ($1) increments) using the total income distribution and expenditure distribution for the country and the parameters (e.g., x people have an income of zero to one dollar ($0-$1) per day, y people have an income of one dollar to two dollars ($1-$2) per day, etc.)

In addition, survey data that includes demographics (e.g., age, gender, education, household size, residence location, or some other demographic) of the respondents from the country (e.g., from household budget surveys, , etc.), is broken down into percentage increments (e.g., five percent (5%)) of income distributions and expenditure distributions (e.g., the poorest five percent (5%) of the population have a maximum income of x, the poorest ten percent (10%) of the population have a maximum income of y, etc.). Respondents are assigned to the percentage increments of the distribution according to their income or expenditures to determine the number of people in each percentage step by their demographic. The share in each percentage step of the income or expenditure distribution is determined for each demographic group by age and gender, or some other demographic (x% of a demographic group is in the poorest five percent (5%), y% of the same demographic group is in the next five percent (5%), etc.). The increments in the national distributions are converted into a single monetary increment (e.g., in one-dollar ($1) increments) and applied to the proportions of demographic groups to the corresponding single monetary groups to determine individuals and income or expenditures of each group by the single monetary increments. The share in each percentage step of the income or expenditure distribution is rescaled to match the total distributions of household income distributions and expenditure distributions of the country.

Turning to FIG. 2, FIG. 2 is a simplified block diagram illustrating example details of a particular non-limiting implementation of the total expenditure per demographic group engine 110 of FIG. 1. The total expenditure per demographic group engine 110 can include an income and expenditure per household engine 202, a distribution of income and expenditures engine 204, and a merge household income and expenditures with distribution of income and expenditures engine 206.

In an illustrative example, the prediction and forecast electronic device 102 and/or the total expenditure per demographic group engine 110 can communicate with one or more of the server 122, the network element 124, and/or cloud services 126 to obtain one or more data sources 130 that are related the income and expenditure distributions of a country as well as to the GDP growth rate of the country. The household expenditure rate for the country is allowed to grow with the GDP growth rate. In addition, the prediction and forecast electronic device 102 can communicate with one or more of the server 122, the network element 124, and cloud services 126 to obtain one or more data sources 130 that are related to national accounts data and determine the savings rate for the country.

The income and expenditures per household engine 202 in the total expenditure per demographic group engine 110 can create continuous income and expenditures distributions based off of the forecasted expenditure and the savings rate of the country. In some examples, the income and expenditures are broken down into one percent (1%) steps such that the poorest one percent (1%) income and expenditures is determined (for example, the poorest has 0.2 of the total expenditures) all the way up to one-hundred percent (100%). The one percent (1%) steps provide data at all percentages from one percent (1%) to one hundred percent (100%). Note that the data from the one or more data sources 130 typically does not include all the percentages. By breaking down the income and expenditures into one percent (1%) steps, the income and expenditures for a specific country can be homogenized or harmonized to allow for comparison with other countries.

In addition, using the distribution of income and expenditures engine 204, the prediction and forecast electronic device 102 and/or the total expenditure per demographic group engine 110 can communicate with one or more of the server 122, the network element 124, and cloud services 126 to obtain one or more data sources 130 that are related to demographic information of people in the country. In some examples, the data is survey data related to demographic information of people in the country. The national distribution of income and expenditures of people in the country is broken down into percentage steps (e.g., five percent (5%) steps) to identify the expenditures or income levels of the poorest five percent (5%), the poorest ten percent (10%), etc. The people in the survey are then grouped into one of the percentage steps. Each person's weight (the number of people in the population of the country that the person represents) in the survey is aggregated to allow each person in the survey to represent a portion of the population of the country with the same demographics. In some examples, the weight of each person is aggregate by the percentages, the brackets in the distribution, as well as by the demographics represented by the survey. For each demographic group, the share of the demographic group in each percentage step is determined. For example, for each demographic group, the system determines what share of that group is in the poorest five percent (5%), the next five percent (5%) and so on (e.g., six percent (6%) of a specific demographic group is in a specified five percent (5%) step). By determining the share of the demographic group in each percentage step, the demographic data can be compared with the national data and the forecasted income and expenditures of the national population that was broken into one percent (1%) steps can be used to forecast income and expenditures distributions for a specific demographic group of people in the country.

The merge household income and expenditures with distribution of income and expenditures engine 206 can be configured to merge the distribution of income and expenditures for the households in continuous percentage steps with the percentage steps of the determined distribution of income and expenditures for a specific demographic group to create a distribution of income and expenditures for the specific demographic group. For example, the scale distributions engine 502 (illustrated in FIG. 5) can be configured to scale and merge the distribution of income and expenditures for the households in continuous percentage steps with the percentage steps of the determined distribution of income and expenditures for the specific demographic group to create a distribution of income and expenditures for the specific demographic group. The scaling helps to ensure the determined distribution of income and expenditures for the specific demographic group matches the distribution of income and expenditures for the households.

The scaling is performed iteratively until the distribution of income and expenditures for the households in continuous percentage steps is approximately equal to the percentage steps of the determined distribution of income and expenditures for the specific demographic group. In a specific example, a matrix may be used where the row sums correspond to the numbers of people by expenditures group and the column sums correspond to the numbers of people by demographic group. Each cell in the matrix includes the number of people by the demographic group and expenditures group. The numbers are iteratively adjusted to make sure they add up to both the correct numbers of people by expenditures group and the correct numbers of people by demographic group.

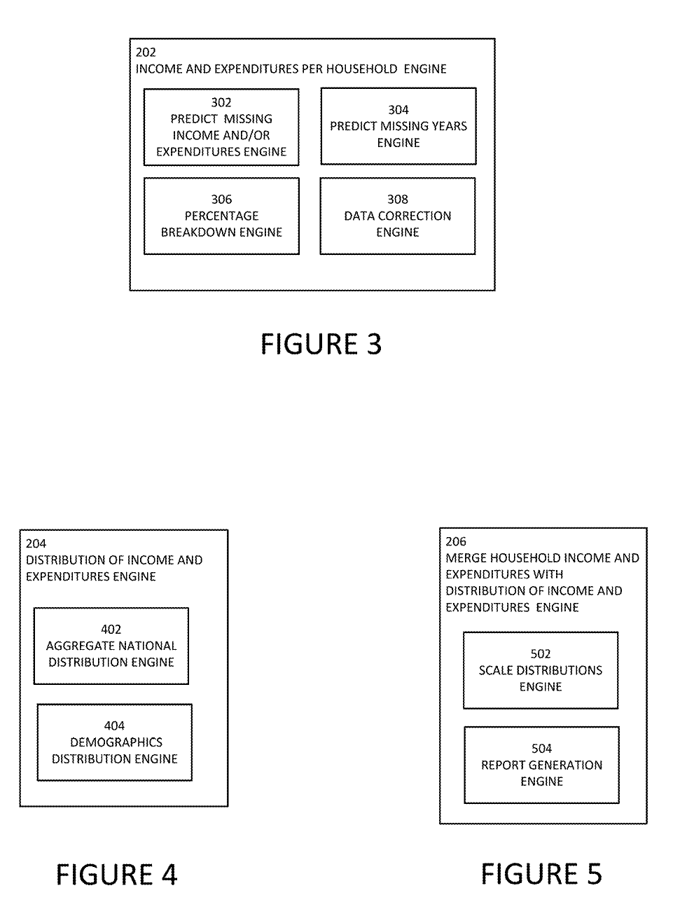

Turning to FIG. 3, as illustrated in FIG. 3, the income and expenditures per household engine 202 can include a predict missing income and/or expenditures engine 302, a predict missing years engine 304, a percentage breakdown engine 306, and a data correction engine 308.

The predict missing income and/or expenditures engine 302 can be configured to predict missing income and/or expenditures during a predetermined time range. More specifically, for countries with household expenditure data but missing household income data, the household expenditure distributions can be linked to the household income using linear regressions to forecast the missing household income data in the country. For countries with household income data but missing household expenditure data, the household income can be linked to the household expenditure using linear regressions to forecast the missing household expenditure data in the country. For countries with both missing household income data and missing household expenditure data, known household income data and/or household expenditure data from one or more countries with similar socioeconomic data can be used to estimate the missing household income data and/or the missing household expenditure data.

The predict missing years engine 304 can be configured to predict the data for years during the predetermined time range that do not include data. For example, interpolation of the household income and the household expenditure distributions in the country can be used to predict income distributions and expenditure distributions during years of the predetermined time period where the data is missing.

The percentage breakdown engine 306 can be configured to use the total income and expenditure of the country and break it down into the income distributions and expenditure distributions for the country in percentage increments (e.g., 0.1% increments or some other percentage increment). More specifically, the total income and expenditure of the country can be broken down such that a first percentage increment of the population of the country has X percent of the total income of the country (e.g., the poorest 0.1% of the population of the country has 0.05% of the total income), the next second percentage increment of the population of the country has Y percent of the total income (e.g., the poorest 0.2% of the population of the country has 0.1% of the total income), the third percentage increment of the population of the country has Z percent of the total income (e.g., the poorest 0.3% of the population of the country has 0.15% of the total income), etc.

The data correction engine 308 can be configured to adjust distributions of household income and expenditures such that the sum of household income and expenditures from the distribution equals the total income and expenditure for the country. In a specific example, the data correction engine 208 can be configured to adjust distributions of household income and expenditures using a weighted adjustment as opposed to a linear adjustment because if the whole distribution or all the household income distributions and expenditure distributions are scaled linearly to match the total income and expenditure for the country, there would not be any poor people in the country because everybody was shifted up. Instead, extra expenditures are added to the households with higher income or expenditure such that the higher a household's income or expenditure, the more it is shifted up. The process can be iteratively repeated to shift the upper end more and more until the sum of all the household income and expenditure from the corresponding distributions is equal to the total income and expenditure for the country.

Turning to FIG. 4, FIG. 4 is a simplified block diagram illustrating example details of a particular non-limiting implementation of the distribution of income and expenditures engine 204. The distribution of income and expenditures engine 204 can include an aggregate national distribution engine 402 and a demographics distribution engine 404.

The aggregate national distribution engine 402 can be configured to aggregate respondents to a survey of people in the country to allow the population of the country to be represented by each person that responded to the survey. More specifically, the survey may be a survey that creates survey data related to demographic information of people in the country. The national distribution of income and expenditures of people in the country can be broken down into percentage steps (e.g., five percent (5%) steps) to identify the expenditures or income levels of the poorest five percent (5%), poorest ten percent (10%), etc. The people in the survey are then grouped into one of the percentage steps such that the whole population is fit into the brackets and such that there is a portion of the population in each bracket. Each person's weight (the number of people in the population of the country that the person represents) in the survey is aggregated to allow the population of the country to be represented by each person in the survey.

The demographics distribution engine 404 can be configured to determine the percentage share of each demographic group. For example, the weight of each person is aggregate by the percentages, the brackets in the distribution, as well as by the demographics represented by the survey. Then for each demographic, the share of the demographic group in each percentage step is determined. For example, for each demographic group, the demographics distribution engine 404 determines what share of that group is in the poorest five percent (5%), the next five percent (5%) and so on (e.g., six percent (6%) of a specific demographic group are in a specified five percent (5%) step). By determining the share of the demographic group in each percentage step, the demographic data can be compared with the national data and the forecasted income and expenditures of the national population that was broken down into one percent (1%) steps can be used to forecast income and expenditures distributions for a specific demographic group of people in a country.

Turning to FIG. 5, FIG. 5 is a simplified block diagram illustrating example details of a particular non-limiting implementation of the merge household income and expenditures with distribution of income and expenditures engine 206. The merge household income and expenditures with distribution of income and expenditures engine 206 can include a scale distributions engine 502 and a report generation engine 504.

The scale distributions engine 502 can be configured to merge the distribution of income and expenditures for the households in continuous percentage steps with the percentage steps of the determined distribution of income and expenditures for a specific demographic group to create a distribution of income and expenditures for the specific demographic group. For example, the scale distributions engine 502 can be configured to scale and merge the distribution of income and expenditures for the households in continuous percentage steps with the percentage steps of the determined distribution of income and expenditures for the specific demographic group to create a distribution of income and expenditures for the specific demographic group. The scaling helps to ensure the determined distribution of income and expenditures for the specific demographic group matches the distribution of income and expenditures for the households.

The scaling is performed iteratively until the distribution of income and expenditures for the households in continuous percentage steps is approximately equal to the percentage steps of the determined distribution of income and expenditures for the specific demographic group. In a specific example, a matrix may be used where the row sums correspond to the numbers of people by expenditures group and the column sums correspond to the numbers of people by demographic group. Each cell in the matrix includes the number of people by the demographic group and expenditures group. The numbers are iteratively adjusted to make sure they add up to both the correct numbers of people by expenditures group and the correct numbers of people by demographic group.

The report generation engine 504 can be used to generate reports to help enable determining and forecasting demographic expenditures on one or more categories of goods and/or services. For example, the report generation engine 504 can generate a financial report of a country, compare two or more countries, generate forecasted income and expenditures distributions for a specific demographic of people in one or more countries, or other reports to help enable determining and forecasting demographic expenditures on one or more categories of goods and/or services.

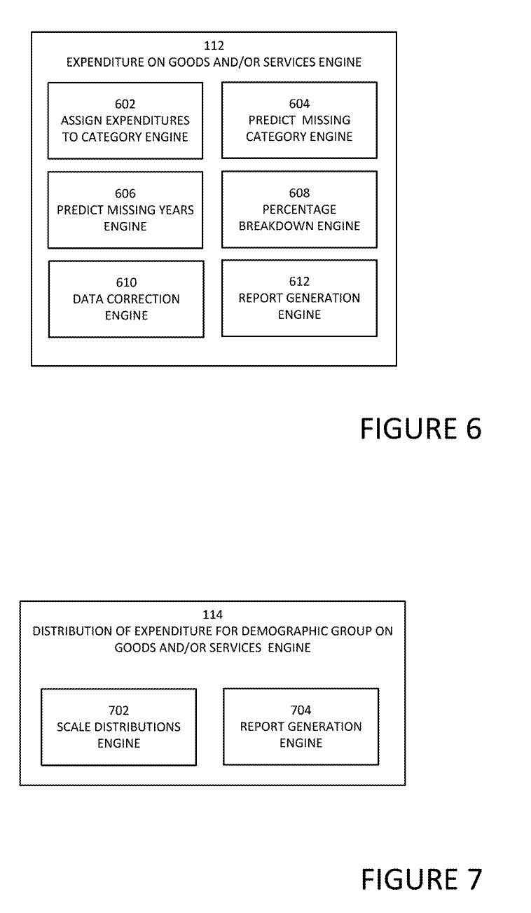

Turning to FIG. 6, FIG. 6 is a simplified block diagram illustrating example details of a particular non-limiting implementation of the expenditure on goods and/or services engine 112 of FIG. 1. The expenditure on goods and/or services engine 112 can include an assign expenditures to category engine 602, a predict missing category engine 604, a predict missing years engine 606, a percentage breakdown engine 608, a data correction engine 610, and a report generation engine 612.

The assign expenditures to category engine 602 can be configured to assign expenditures to one or more goods and/or services to help enable a determination of the share of total expenditures for one or more categories of goods and/or services for a country. In a specific illustrative example, a portion of the total spending for a demographic group is allocated to one or more categories from the COICOP classification and in some examples, subcategories from the COICOP classification. In another specific illustrative example, a portion of the total spending for a demographic group is allocated to one or more categories that are not included in the COICOP classification where unique definitions for the categories that are not included in the COICOP classification can be created and alternative datasets can be used to estimate the shares of spending for the categories that are not included in the COICOP classification.

The predict missing category engine 604 can be configured to allocated a portion of the total expenditures for the demographic group to one or more categories or subcategories where expenditure data for the one or more categories or subcategories is unavailable. In a specific illustrative example, to allocated a portion of the total expenditures for the demographic group into one or more categories or subcategories where expenditure data for the one or more categories or subcategories is missing, a similar country with a known portion of the total expenditures for the demographic groups allocated to the one or more categories or subcategories that is missing is used to estimate the portion of the total expenditures for the assign expenditure in the one or more categories or subcategories where the expenditure data is missing. In another specific illustrative example, if expenditure data is missing for a subcategory of a category and expenditure data is available for the other subcategory or categories of the category, the missing expenditure data for the subcategory can be determined by subtracting the known expenditure for the other subcategories from the total expenditure of the category.

The predict missing years engine 606 can be configured to assign expenditures to one or more goods and/or services during years where expenditure data is missing to help enable a determination of the share of total expenditures for one or more categories of goods and/or services for a country during a specific year. In a specific illustrative example, the expenditures for one or more goods and/or services for missing years for a specific country can be determined using the year-to-year growth rates of model estimates for the specific country.

The percentage breakdown engine 608 can be configured to break down the expenditure of a demographic group for one or more goods and/or services in percentage steps such that the income and expenditures of a certain percentage (the poorest five percent (5%)) is "X" percent. By breaking down the expenditure of a demographic group for one or more goods and/or services in percentage steps, the expenditure of the demographic group for one or more goods and/or services can be harmonized to allow for comparisons between different countries.

The data correction engine 610 can be configured to determine minor adjustments to the demographic group's expenditures on a specific category to ensure that all the demographic groups add up to the national expenditure on that specific category. In addition, the data correction engine 610 can be configured determine minor adjustments to subcategory expenditures to ensure that all subcategory expenditures for the demographic group add up the demographic group's expenditure on the parent category. In a specific illustrative example, at each category and subcategory level, a factor estimation algorithm can be used to perform iterative proportional fitting where, at each category and subcategory level, a factor estimation algorithm ensures that all subcategory expenditures for the demographic group add up the demographic group's expenditure on the parent category and all the demographic groups add up to the national expenditure on the parent category.

The report generation engine 612 can be configured to generate reports to help enable determining and forecasting demographic expenditures on one or more categories of goods and/or services. For example, the report generation engine 504 can generate a financial report of a country, compare two or more countries, generate forecasted income and expenditures distributions for a specific demographic of people on one or more goods and/or services, or other reports to help enable determining and forecasting demographic expenditures on one or more categories of goods and/or services.

Turning to FIG. 7, FIG. 7 is a simplified block diagram illustrating example details of a particular non-limiting implementation of the distribution of expenditure per demographic group on goods and/or services engine 114 of FIG. 1. The distribution of expenditure per demographic group on goods and/or services engine 114 can include a scale distributions engine 702 and a report generation engine 704.

The scale distributions engine 702 can be configured to use the breakdown of the total expenditure of a demographic group in a country as determined by the total expenditure per demographic group engine 110 and the breakdown of the national expenditure of the county into one or more categories of goods and/or services determined by the expenditure on goods and/or services engine 112 to determine the category or subcategory expenditure of the demographic group in the country for the one or more categories of goods and/or services. In some examples, the scale distributions engine 702 can be configured to use the income and expenditures distributions for a specific demographic of people in a country determined by the total expenditure per demographic group engine 110 and the share of total expenditures for one or more categories of goods and/or services for the country determined by the expenditure on goods and/or services engine 112 to determine the category or subcategory expenditure of the demographic group in the country for a given year.

More specifically, once the expenditures at the national level per one or more categories of goods and/or services of every country every year from a given range (e.g., year 2000 to year 2050) is determined, the expenditures at the national level per one or more categories of goods and/or services can be broken down by age and spending groups suing the core spending data and spending by age across spending groups. For example, the total national spending on food for a given country can be broken down by age across spending groups and allocated it into different spending groups. For example, for Austria, in total, if the national expenditure on food is around fifteen percent (15%) of the total national expenditure, the system can determine how much poor people age forty-five to sixty-five (45-65) in Austria spend on food.

Using household surveys, spending distributions by different kinds of spending levels of different houses can be determine and using different information about the individuals in the house and the system can estimate how much of food is being consumed by the adults in a household verses children in the household. The shares for different demographic groups are obtained from surveys.

The report generation engine 704 can be configured to generate reports to help enable determining and forecasting demographic expenditures on one or more categories of goods and/or services. For example, the report generation engine 504 can generate a financial report of a country, compare two or more countries, generate forecasted income and expenditures distributions for a specific demographic of people on one or more goods and/or services, or other reports to help enable determining and forecasting demographic expenditures on one or more categories of goods and/or services.

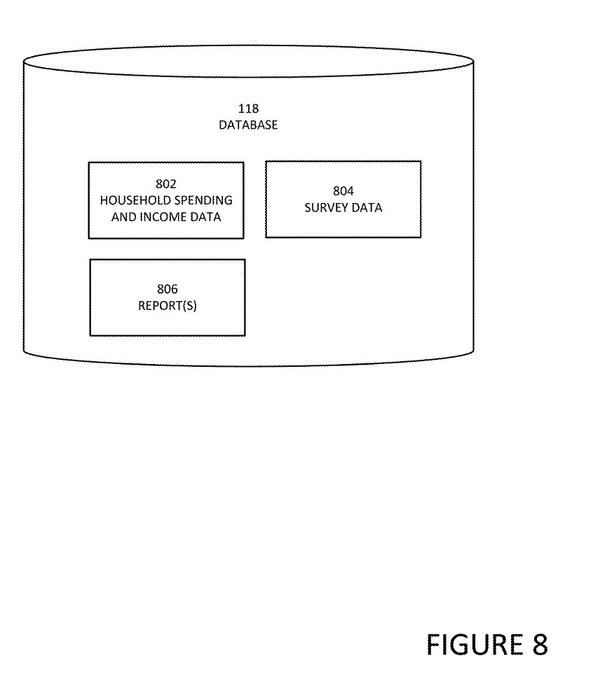

Turning to FIG. 8, FIG. 8 is a simplified block diagram illustrating example details of a particular non-limiting implementation of the database 118 of FIG. 1. The database 118 can include household spending and income data 802, survey data 804, and one or more reports 806. Note that the database 118 can include other data obtained from one or more data sources 130, intermediate data used by the total expenditure per demographic group engine 110, the expenditure on goods and/or services engine 112, and/or the distribution of expenditure per demographic group on goods and/or services engine 114 or other data used by the system to help enable determining and forecasting demographic expenditures on one or more categories of goods and/or services.

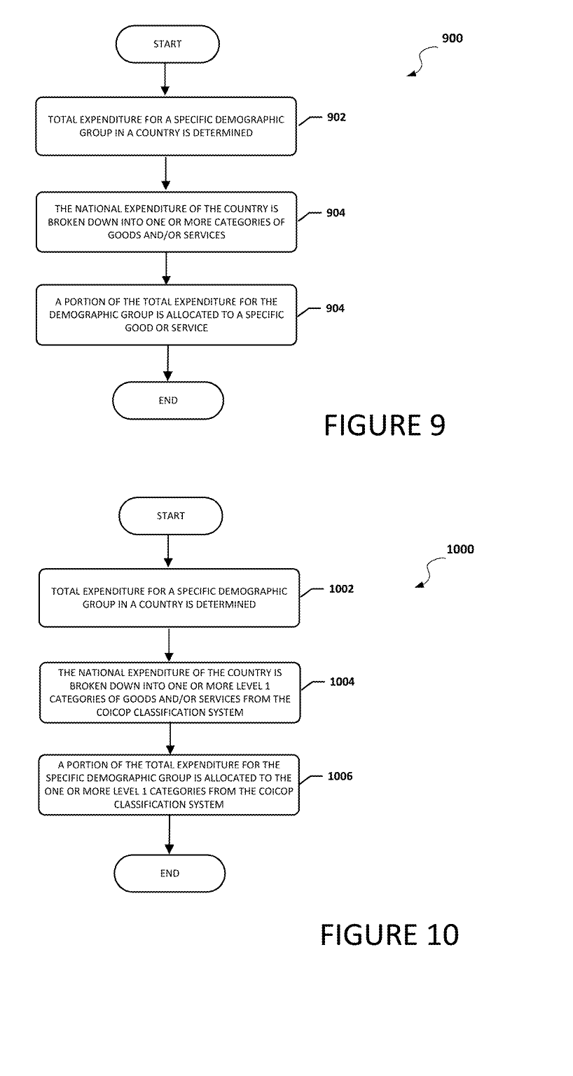

Turning to FIG. 9, FIG. 9 is an example flowchart illustrating possible operations of a flow 900 that may be associated with potential operations to help determine the expenditure of a demographic group on a specific good or service, in accordance with an embodiment of the present disclosure. Specifically, in some examples, one or more operations of flow 900 may be performed by the total expenditure per demographic group engine 110, the expenditure on goods and/or services engine 112, and/or the distribution of expenditure per demographic group on goods and/or services engine 114. At 902, total expenditure for a specific demographic group in a country is determined. For example, the total expenditure per

demographic group engine 110 can be used to help determine total expenditure for a specific demographic group in a country. At 904, the national expenditure of the country is broken down into one or more categories of goods and/or services. For example, the expenditure on goods and/or services engine 112 can be configured to break down the national expenditure of the country into one or more categories of goods and/or services. At 906, a portion of the total expenditure for the specific demographic group is allocated to a specific good or service. For example, the distribution of expenditure per demographic group on goods and/or services engine 114 can be configured to use the breakdown of the total expenditure of a demographic group in a country as determined by the total expenditure per demographic group engine 110 and the breakdown of the national expenditure of the county into one or more categories of goods and/or services determined by the expenditure on goods and/or services engine 112 to determine a portion of the total expenditure for the specific demographic group that is allocated to the specific good or service.

Turning to FIG. 10, FIG. 10 is an example flowchart illustrating possible operations of a flow 1000 that may be associated with potential operations to help determine the expenditure of a demographic group on one or more goods and/or services under the COICOP classification system, in accordance with an embodiment of the present disclosure. Specifically, in some examples, one or more operations of flow 1000 may be performed by the total expenditure per demographic group engine 110, the expenditure on goods and/or services engine 112, and/or the distribution of expenditure per demographic group on goods and/or services engine 114. At 1002, total expenditure for a specific demographic group in a country is determined. For example, the total expenditure per demographic group engine 110 can be used to help determine total expenditure for a specific demographic group in a country. At 1004, the national expenditure of the country is broken down into one or more Level 1 categories of goods and/or services from the COICOP classification system. For example, the expenditure on goods and/or services engine 112 can be configured to break down the national expenditure of the country into one or more Level 1 categories of goods and/or services from the COICOP classification system. At 1006, a portion of the total expenditure for the specific demographic group is allocated to the one or more Level 1 categories from the COICOP classification system.

For example, the distribution of expenditure per demographic group on goods and/or services engine 114 can be configured to use the breakdown of the total expenditure of a demographic group in a country as determined by the total expenditure per demographic group engine 110 and the breakdown of the national expenditure of the county into one or more Level 1 categories of goods and/or services from the COICOP classification system determined by the expenditure on goods and/or services engine 112 to determine a portion of the total expenditure for the specific demographic group that is allocated to the one or more Level 1 categories from the COICOP classification system.

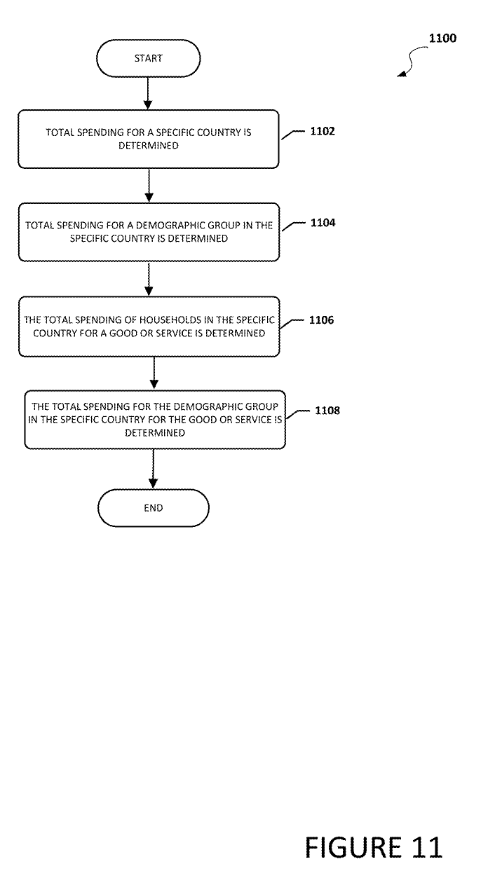

Turning to FIG. 11, FIG. 11 is an example flowchart illustrating possible operations of a flow 1100 that may be associated with potential operations to help determine the total spending of a demographic group in a specific country for a good or service, in accordance with an embodiment of the present disclosure. Specifically, in some examples, one or more operations of flow 1100 may be performed by the total expenditure per demographic group engine 110, the expenditure on goods and/or services engine 112, and/or the distribution of expenditure per demographic group on goods and/or services engine 114. At 1102, the total spending for a specific country is determined. At 1104, the total spending for a demographic group in the specific country is determined. For example, the total expenditure per demographic group engine 110 can be used to help determine the total spending for the specific country and the total spending for a specific demographic group in the specific country.

At 1106, the total spending of households in the specific country for a good or service is determined. For example, the expenditure on goods and/or services engine 112 can be configured to determine the total spending of households in the specific country for a good or service. At 1108, the total spending for the demographic group in the specific country for the good or service is determined. For example, the distribution of expenditure per demographic group on goods and/or services engine 114 can be configured to use the total spending for a demographic group in the specific country as determined by the total expenditure per demographic group engine 110 and the total spending of households in the specific country for a good or service determined by the expenditure on goods and/or services engine 112 to determine the total spending for the demographic group in the specific country for the good or service.

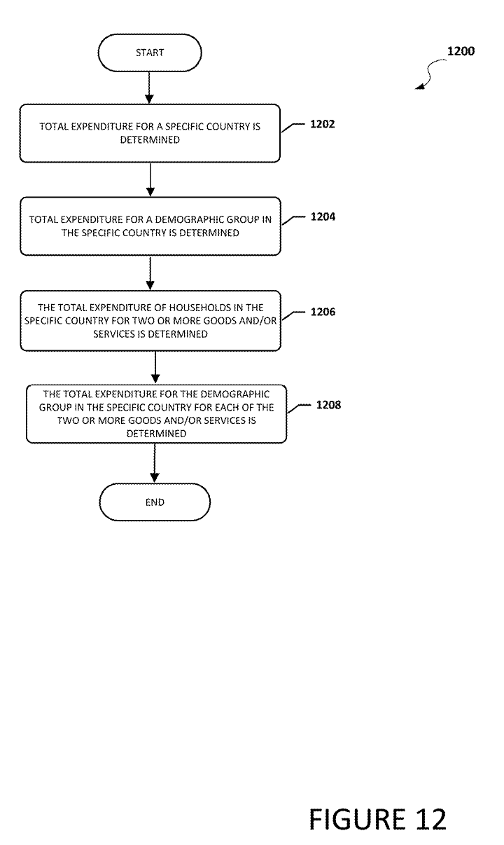

Turning to FIG. 12, FIG. 12 is an example flowchart illustrating possible operations of a flow 1200 that may be associated with potential operations to help determine the total expenditure of a demographic group in a specific country for one or more goods or services, in accordance with an embodiment of the present disclosure. Specifically, in some examples, one or more operations of flow 1200 may be performed by the total expenditure per demographic group engine 110, the expenditure on goods and/or services engine 112, and/or the distribution of expenditure per demographic group on goods and/or services engine 114. At 1202, the total expenditure for a specific country is determined. At 1204, the total expenditure for a demographic group in the specific country is determined. For example, the total expenditure per demographic group engine 110 can be used to help determine the total expenditure for the specific country and the total expenditure for a specific demographic group in the specific country.

At 1206, the total expenditure of households in the specific country for two or more good or service is determined. For example, the expenditure on goods and/or services engine 112 can be configured to determine the total expenditure of households in the specific country for two or more goods and/or services. At 1208, the total expenditure for the demographic group in the specific country for each of the two or more the goods and/or services is determined. For example, the distribution of expenditure per demographic group on goods and/or services engine 114 can be configured to use the total spending for a demographic group in the specific country as determined by the total expenditure per demographic group engine 110 and the total spending of households in the specific country for two or more goods and/or services determined by the expenditure on goods and/or services engine 112 to determine the total spending for the demographic group in the specific country for each of the two or more goods and/or services.

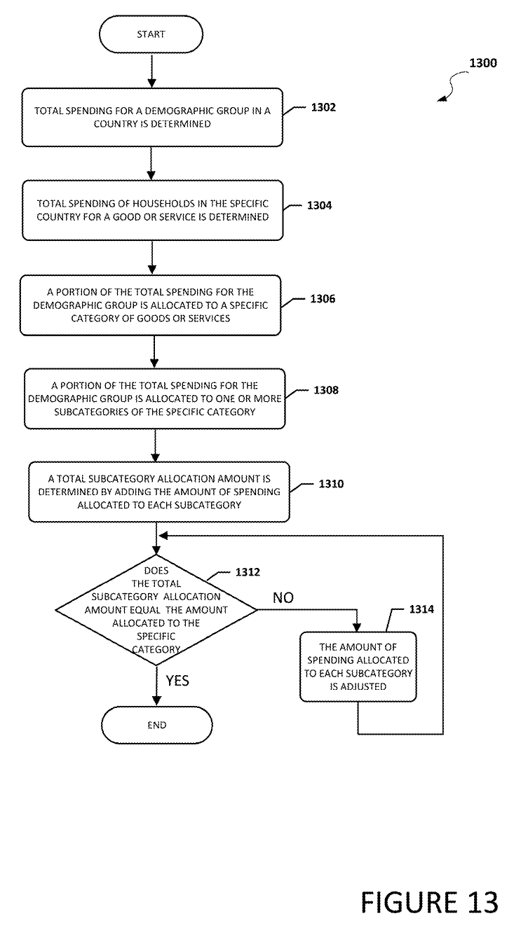

Turning to FIG. 13, FIG. 13 is an example flowchart illustrating possible operations of a flow 1300 that may be associated with potential operations to help determine the total expenditure of a demographic group in a specific country for one or more goods or services, in accordance with an embodiment of the present disclosure. Specifically, in some examples, one or more operations of flow 1300 may be performed by the total expenditure per demographic group engine 110, the expenditure on goods and/or services engine 112, and/or the distribution of expenditure per demographic group on goods and/or services engine 114. At 1302, total spending for a demographic group in a country is determined. For example, the total expenditure per demographic group engine 110 can be configured to determine the total spending for a demographic group in a country. At 1304, the total spending of households in the specific country for a good or service is determined. For example, the expenditure on goods and/or services engine 112 can be configured to determine the total spending of households in the specific country for a good or service. At 1306, a portion of the total spending for the demographic group is allocated to a specific category of goods or services. For example, the expenditure on goods and/or services engine 112 can be configured to allocate a portion of the total spending for the demographic group to a specific category of goods or services. At 1308, a portion of the total spending for the demographic group is allocated to one or more subcategories of the specific category. For example, the expenditure on goods and/or services engine 112 can be configured to allocate a portion of the total spending for the demographic group to one or more subcategories of the specific category. At 1310, a total subcategory allocation amount is determined by adding the amount of spending allocated to each subcategory. For example, the expenditure on goods and/or services engine 112 can be configured to determine a total subcategory allocation amount by adding the amount of spending allocated to each subcategory. At 1312, the system determines if the total subcategory allocation amount equals the amount allocated to the specific category. If the total subcategory allocation amount does not equal the amount allocated to the specific category, the amount of spending allocated to each subcategory is adjusted, as in 1314, and the system again determines if the total subcategory allocation amount equals the amount allocated to the specific category. For example, the expenditure on goods and/or services engine 112 can be configured to determine if the total subcategory allocation amount equals the amount allocated to the specific category and if the total subcategory allocation amount does not equal the amount allocated to the specific category, the expenditure on goods and/or services engine 112 can be configured to adjust amount of spending allocated to each subcategory until the total subcategory allocation amount equals the amount allocated to the specific category.

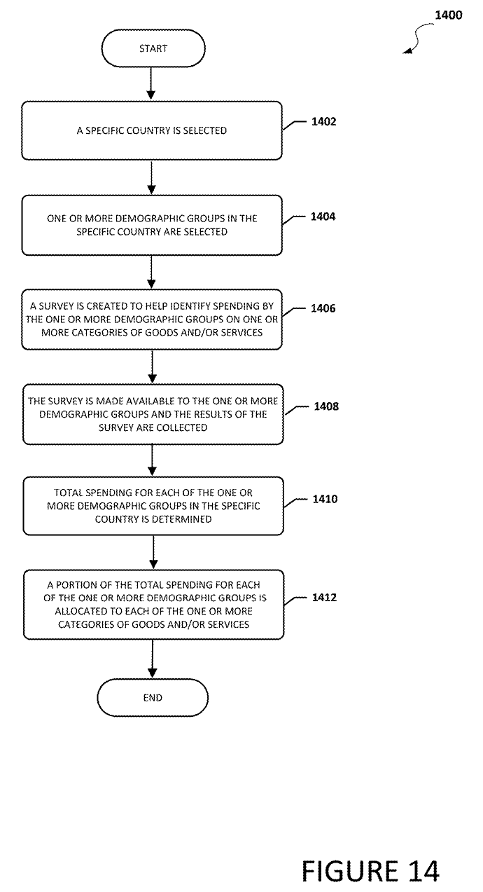

Turning to FIG. 14, FIG. 14 is an example flowchart illustrating possible operations of a flow 1400 that may be associated with potential operations to help determine the total expenditure of a demographic group in a specific country for one or more goods or services, in accordance with an embodiment of the present disclosure. Specifically, in some examples, one or more operations of flow 1400 may be performed by the total expenditure per demographic group engine 110, the expenditure on goods and/or services engine 112, and/or the distribution of expenditure per demographic group on goods and/or services engine 114. At 1402, a specific country is selected. At 1404, one or more demographic groups in the specific country are selected. At 1406, a survey is created to help identify spending by the one or more demographic groups on one or more categories of goods and/or services. At 1408, the survey is made available to the one or more demographic groups and the results of the survey are collected. At 1410, total spending for each of the one or more demographic groups in the specific country is determined. At 1412, a portion of the total spending for each of the one or more demographic groups is allocated to each of the one or more categories of goods and/or services.

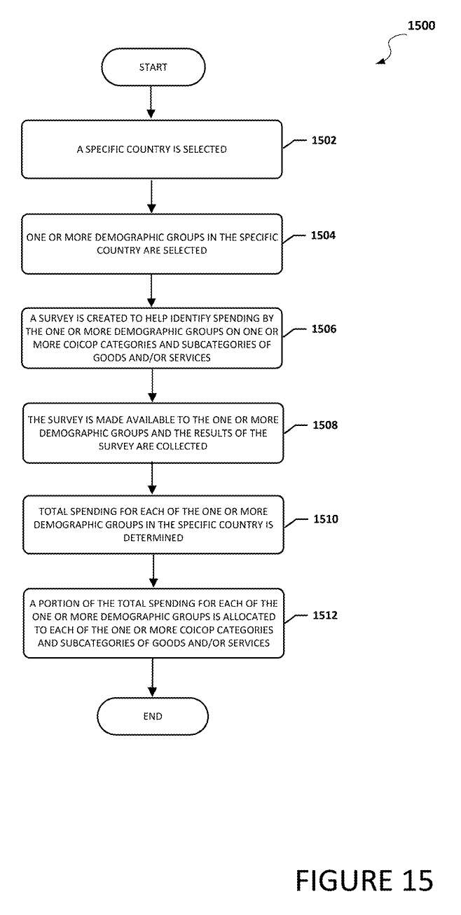

Turning to FIG. 15, FIG. 15 is an example flowchart illustrating possible operations of a flow 1500 that may be associated with potential operations to help determine the total expenditure of a demographic group in a specific country for one or more goods or services, in accordance with an embodiment of the present disclosure. Specifically, in some examples, one or more operations of flow 1500 may be performed by the total expenditure per demographic group engine 110, the expenditure on goods and/or services engine 112, and/or the distribution of expenditure per demographic group on goods and/or services engine 114. At 1502, a specific country is selected. At 1504, one or more demographic groups in the specific country are selected. At 1506, a survey is created to help identify spending by the one or more demographic groups on one or more COICOP categories and subcategories of goods and/or services. At 1508, the survey is made available to the one or more demographic groups and the results of the survey are collected. At 1510, total spending for each of the one or more demographic groups in the specific country is determined. At 1512, a portion of the total spending for each of the one or more demographic groups is allocated to each of the one or more COICOP categories and subcategories of goods and/or services.

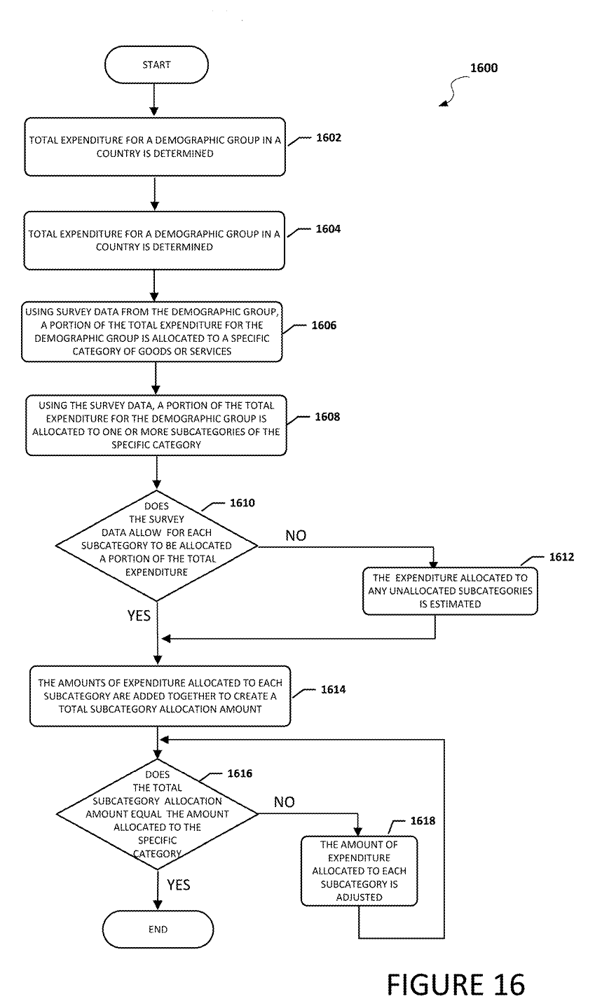

Turning to FIG. 16, FIG. 16 is an example flowchart illustrating possible operations of a flow 1600 that may be associated with potential operations to help determine the total expenditure of a demographic group in a specific country for one or more goods or services, in accordance with an embodiment of the present disclosure. Specifically, in some examples, one or more operations of flow 1600 may be performed by the total expenditure per demographic group engine 110, the expenditure on goods and/or services engine 112, and/or the distribution of expenditure per demographic group on goods and/or services engine 114. At 1602, total expenditure for a demographic group in a country is determined. For example, the total expenditure per demographic group engine 110 can be configured to determine the total expenditure for a demographic group in a country. At 1604, the total expenditure for a demographic group in the specific country is determined. For example, the expenditure on goods and/or services engine 112 can be configured to determine the total expenditure for a demographic group in the specific country. At 1606, using survey data from the demographic group, a portion of the total expenditure for the demographic group is allocated to a specific category of goods or services. For example, the expenditure on goods and/or services engine 112 can be configured to analyze results of one or more surveys and allocate a portion of the total spending for the demographic group to a specific category of goods or services. At 1608, using survey data from the demographic group, a portion of the total expenditure for the demographic group is allocated to one or more subcategories of the specific category of goods or services. For example, the expenditure on goods and/or services engine 112 can be configured to analyze results of one or more surveys and allocate a portion of the total spending for the demographic group to a specific subcategory of the specific category of goods or services.

At 1610, the system determines if the survey data allows for each subcategory of the specific category to be allocated a portion of the total expenditure for the demographic group. If the survey data does not allow for each subcategory of the specific category to be allocated a portion of the total expenditure for the demographic group, the expenditure allocated to any unallocated subcategories is estimated, as in 1612. For example, the expenditure on goods and/or services engine 112 can be configured to estimate a portion of the total expenditure for the demographic group to allocated to any unallocated subcategories.

At 1616, the amounts of expenditure allocated to each subcategory are added together to create a total subcategory allocation amount. At 1616, the system determines if the total subcategory allocation amount equals the amount allocated to the specific category. If the total subcategory allocation amount does not equal the amount allocated to the specific category, the amount of spending allocated to each subcategory is adjusted, as in 1618, and the system again determines if the total subcategory allocation amount equals the amount allocated to the specific category. For example, the expenditure on goods and/or services engine 112 can be configured to determine if the total subcategory allocation amount equals the amount allocated to the specific category and if the total subcategory allocation amount does not equal the amount allocated to the specific category, the expenditure on goods and/or services engine 112 can be configured to adjust amount of spending allocated to each subcategory until the total subcategory allocation amount equals the amount allocated to the specific category.

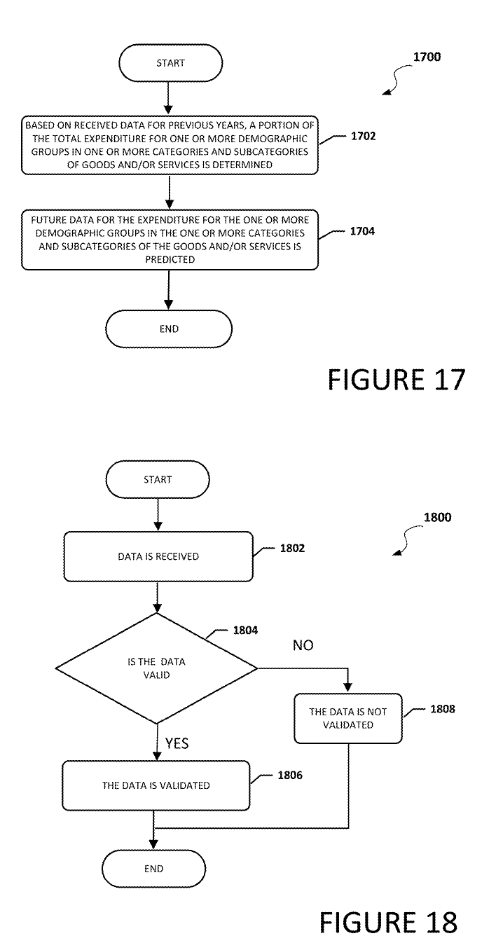

Turning to FIG. 17, FIG. 17 is an example flowchart illustrating possible operations of a flow 1700 that may be associated with potential operations to help determine the total expenditure of a demographic group in a specific country for one or more goods or services, in accordance with an embodiment of the present disclosure. Specifically, in some examples, one or more operations of flow 1700 may be performed by the total expenditure per demographic group engine 110, the expenditure on goods and/or services engine 112, and/or the distribution of expenditure per demographic group on goods and/or services engine 114. At 1702, based on received data for previous years, a portion of the total expenditure for one or more demographic groups in one or more categories and subcategories of goods and/or services is determined. At 1704, future data for the expenditure for the one or more demographic groups in the one or more categories and subcategories of the goods and/or services is predicted.

Turning to FIG. 18, FIG. 18 is an example flowchart illustrating possible operations of a flow 1800 that may be associated with potential operations to help determine the total expenditure of a demographic group in a specific country for one or more goods or services, in accordance with an embodiment of the present disclosure. Specifically, in some examples, one or more operations of flow 1800 may be performed by the total expenditure per demographic group engine 110, the expenditure on goods and/or services engine 112, and/or the distribution of expenditure per demographic group on goods and/or services engine 114. At 1802, data is received. For example, the data can be received from one or more data sources 130. The data can be relevant data that will be included in helping to determine the total expenditure of a demographic group in a specific country for one or more goods or services. At 1804, the system determines if the data is valid. For example, the data can be from a known trustworthy source and/or analyzed to determine if the data is the correct type of data and does not include any egregious anomalies or errors. For example, a trustworthy source may be the WB, the IIASA, the IMF, the OECD, or some other established source of accurate data. In some examples, the data can be acquired from two or more different sources and to determine if the data is valid, the data from the two or more different sources can be compared to each other to see if they are the same or similar. If data acquired from two or more sources is similar, the data can be merged, averaged, or otherwise combined. If the data is valid, the data is validated, as in 1806 and can be used to help determine the total expenditure of a demographic group in a specific country for one or more goods or services. If the data is not valid, the data is not validated, as in 1808. Data that is not validated is disregarded and/or not used.

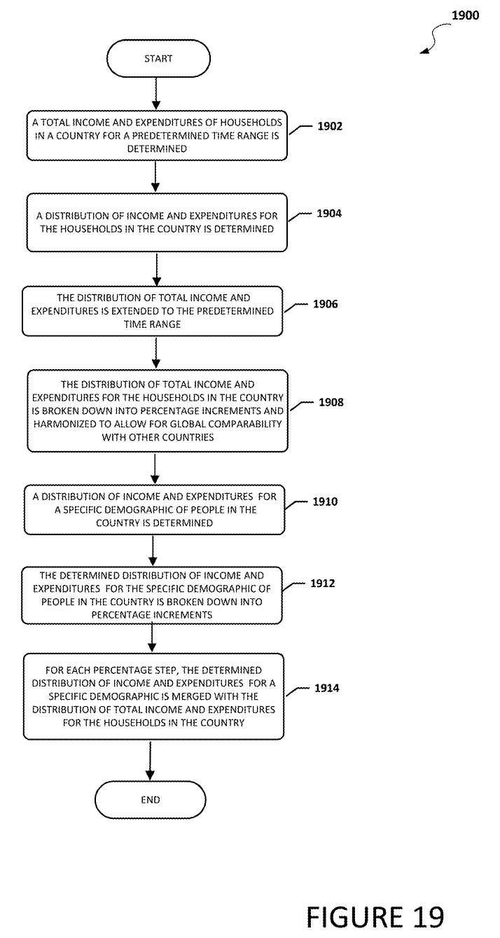

Turning to FIG. 19, FIG. 19 is an example flowchart illustrating possible operations of a flow 1900 that may be associated with potential operations to help enable forecasting income and expenditures distributions, in accordance with an embodiment of the present disclosure. Specifically, in some examples, one or more operations of flow 1900 may be performed by the total expenditure per demographic group engine 110, the income and expenditures per household engine 202, the distribution of income and expenditures engine 204, and/or the merge household income and expenditures with distribution of income and expenditures engine 206. At 1902, the total income and expenditures of households in a country for a predetermined time range is determined. The predetermined time range can be ten prior years from the current year to fifty future years from the current year, from twenty prior years from the current year to ten future years from the current year, or some other predetermined time range, depending on user preference and system constraints. In an example, forecasts of household income and expenditure data for a total population of a country and per capita of the country can be obtained from one or more data sources 130. In some examples, the data can be validated (e.g., see FIG. 18). The data can be used to generate GDP growth rates for the country and the total household expenditures for the country can be increased based on the growth rate of the GDP. To forecast a savings rate for the country, averages of the savings rate from past years may be used. The savings rate of the country can be applied to estimate incomes based on expenditures using data from one or more data sources 130 on household savings and household disposable income. In a specific example, the savings rate is equal to the household savings divided by the household disposable income. To determine incomes based on expenditures and the savings rates, the income can be equal to expenditure divided by one minus the savings rate (income = expenditure/(1- savings rate)).

At 1904, a distribution of income and expenditures for the households in the country is determined. For example, using total income and expenditure of the country from one or more data sources 130, the income distributions and expenditure distributions for the country can be broken down in percentage increments (e.g., 0.1% increments or some other percentage increment) by the distribution of income and expenditures engine 204. More specifically, the total income and expenditure of the country can be broken down such that a first percentage increment of the population of the country has "X" percent of the total income of the country (e.g., the poorest 0.1% of the population of the country has 0.05% of the total income), the next second percentage increment of the population of the country has "Y" percent of the total income (e.g., the poorest 0.2% of the population of the country has 0.1% of the total income), the third percentage increment of the population of the country has "Z" percent of the total income (e.g., the poorest 0.3% of the population of the country has 0.15% of the total income), etc. In some examples, the distributions of household income and expenditures are adjusted such that the sums of all the household income and expenditure from the corresponding distributions are equal to the total income and expenditure for the country. For countries with household expenditure data but missing household income data, the household expenditure distributions can be linked to the household income using linear regressions to forecast the missing household income data in the country. For countries with household income data but missing household expenditure data, the household income can be linked to the household expenditure using linear regressions to forecast the missing household expenditure data in the country. For countries with both missing household income data and missing household expenditure data, known household income data and/or household expenditure data from one or more countries with similar socioeconomic data can be used to estimate the missing household income data and/or the missing household expenditure data.

At 1906, the distribution of total income and expenditures is extended to the predetermined time range. For example, interpolation of the household income and the household expenditure distributions in the country can be used to predict income distributions and expenditure distributions during missing years of the predetermined time range. The predetermined time range can extend after the last data observations.

At 1908, the distribution of total income and expenditures for the households in the country is broken down into percentage increments and harmonized to allow for global comparability with other countries. For example, the distribution of total income and expenditures for the households in the country is parameterized and the household income and household expenditure distributions are put into monetary increments (e.g., one-dollar increments, one-euro increments, one-yen increments, etc.). More specifically, one or more parameters that describe each country's household income and household expenditure distribution can be estimated. In a non-limiting example, linear regression can be used to estimate three (or more) parameters that describe each household income and household expenditure distribution. The household income and household expenditure distributions are put into monetary increments using the total household income and household expenditures for the country and the estimated one or more parameters that describe each household income and household expenditure distribution. For example, if the monetary increments are in one- dollar increments, "X" number of people have an income of zero to one dollar ($0-$1) per day, "Y" number of people have an income of one dollar to two dollars ($1-$2) per day, etc.

At 1910, a distribution of income and expenditures for a specific demographic of people in the country is determined. For example, using survey data from respondents in the country, demographics can be associated with each respondent and each respondent can be assigned to an increment of the household income distributions and expenditure distributions according to the income and/or expenditures of each respondent. More specifically, in a non- limiting example, five percent increments of household income distributions and expenditure distributions can be identified (e.g., the poorest five percent (5%) of the population of the country have a maximum income of X, the poorest ten percent (10%) of the population of the country have a maximum income of Y, etc.) and each of the respondents to the survey can be assigned to a five percent (5%) increment of household income and expenditure distributions.

At 1912, the determined distribution of income and expenditures for the specific demographic of people in the country is broken down into percentage increments. For example, for each demographic group, the share of each percent increment of household income distributions and expenditure distributions for a specific demographic group is determined. For example, "X" percentage of a demographic group is in the poorest five percent, "Y" percentage of the demographic group is in the next poorest five percent, etc. The demographics can be age, gender, education, household size, residence location, or some other demographic, so long as there is sufficient survey data (e.g., enough respondents with the demographic) to allow the demographic to be assigned to a five percent increment of household income and expenditure distributions.

At 1914, for each percentage step, the determined distribution of income and expenditures for the specific demographic is merged with the distribution of total income and expenditures for the households in the country. For example, each percentage increment of the household income distributions and expenditure distributions may or may not include a percentage of a demographic group (e.g., six percent (6%) of a demographic group may be in a specific five percent (5%) increment of the household income and expenditure distributions). By using the household income and household expenditure distributions in monetary increments the household income distributions and expenditure distributions for each demographic can be determined. In some examples, scaling is used to ensure the total number of people in each percentage increment of the household income distributions and expenditure distributions is equal to or approximately equal to the total population of the country and the total amount of household income distributions and expenditure distributions in each percentage increment is equal to or approximately equal to the total household income distributions and expenditure distributions of the country.

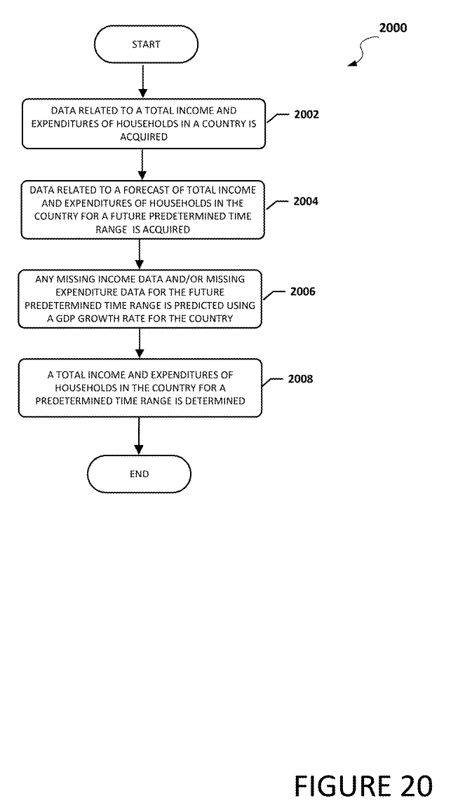

Turning to FIG. 20, FIG. 20 is an example flowchart illustrating possible operations of a flow 2000 that may be associated with potential operations to help enable determining and forecasting demographic expenditures on one or more categories of goods and/or services, in accordance with an embodiment of the present disclosure. Specifically, in some examples, one or more operations of flow 2000 may be performed by the total expenditure per demographic group engine 110, the income and expenditures per household engine 202, the distribution of income and expenditures engine 204, and/or the merge household income and expenditures with distribution of income and expenditures engine 206. At 2002, data related to the total income and expenditures of households in a country is acquired. For example, data related to the total income and expenditures of households in a country can be obtained from one or more data sources 130. In some examples, the data can be validated (e.g., see FIG. 18). At 2004, data related to a forecast of total income and expenditures of households in the country for a future predetermined time range is acquired. For example, forecasts of household income and expenditure data for a total population of a country and per capita of the country can be obtained. In some examples, the data can be validated (e.g., see FIG. 18). The future time range can be fifty future years from the current year, ten future years from the current year, or some other predetermined time range, depending on user preference and system constraints. At 2006, any missing income data and/or missing expenditure data for the future predetermined time range is predicted using a GDP growth rate for the country. At 2008, the total income and expenditures of households in the country for a predetermined time range are determined. For example, using the total income and expenditures of households in the country and the forecasts of total income and expenditures of household in the country for the future predetermined time range, the total income and expenditures of households in the country for the predetermined time range can be determined. The predetermined time range can be ten prior years from the current year to fifty future years from the current year, from twenty prior years from the current year to ten future years from the current year, or some other predetermined time range, depending on user preference and system constraints.

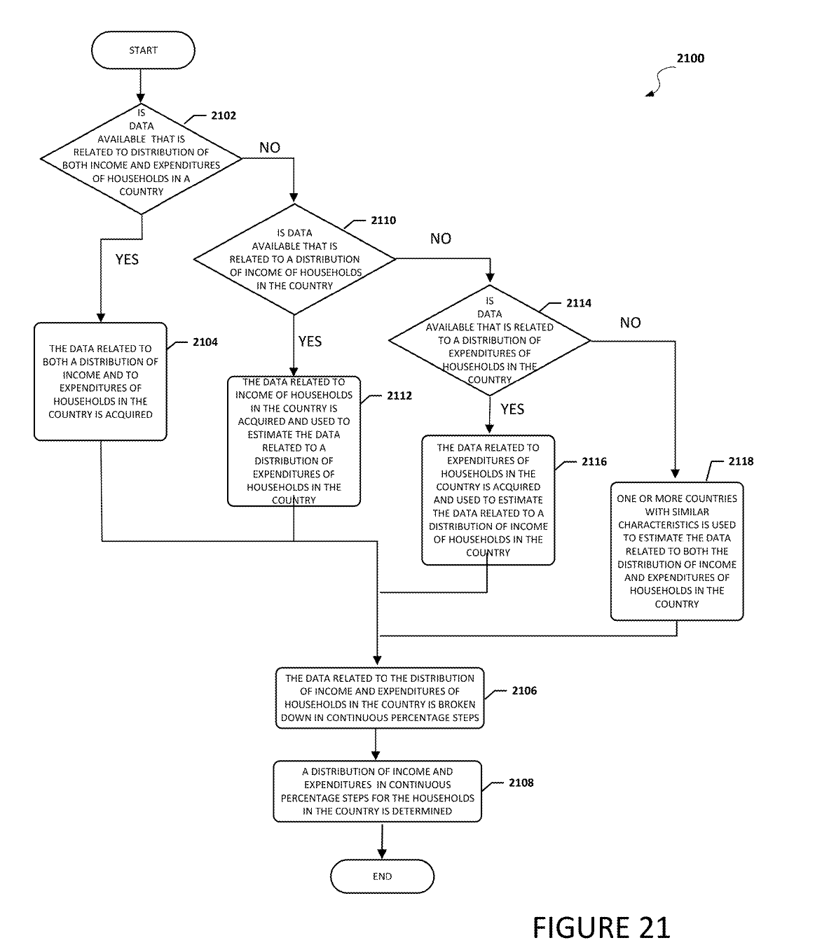

Turning to FIG. 21, FIG. 21 is an example flowchart illustrating possible operations of a flow 2100 that may be associated with potential operations to help enable determining and forecasting demographic expenditures on one or more categories of goods and/or services, in accordance with an embodiment of the present disclosure. Specifically, in some examples, one or more operations of flow 2100 may be performed by the total expenditure per demographic group engine 110, the income and expenditures per household engine 202, the distribution of income and expenditures engine 204, and/or the merge household income and expenditures with distribution of income and expenditures engine 206. At 2102, the system determines if data is available that is related to both a distribution of income and a distribution of expenditures of households in a country. For example, the system determines if data from one or more data sources 130 is available that is related to both distribution of income and to expenditures of households in a country. If data is available that is related to both a distribution of income and to a distribution of expenditures of households in a country, the data related to both a distribution of income and to expenditures of households in the country is acquired, as in 2104. For example, the data related to both a distribution of income and a distribution of expenditures of households in the country can be acquired from the one or more data sources 130. In some examples, the data can be validated (e.g., see FIG. 18). At 2106, the data related to the distributions of income and expenditures of households in the country is broken down into continuous percentage steps. At 2108, distributions of income and expenditures in continuous percentage steps for the households in the country are determined.

Going back to 2102, if the system determines data is not available that is related to both a distribution of income and a distribution of expenditures of households in a country, the system determines if data is available that is related to a distribution of income of households in the country, as in 2110. If data is available that is related to a distribution of income of households in the country, the data related to income of households in the country is acquired and used to estimate the data related to a distribution of expenditures of households in the country, as in 2112. For example, the data related to income of households in the country is acquired from the one or more data sources 130. In some examples, the data can be validated (e.g., see FIG. 18). The data related to income of households in the country is used to estimate the data related to a distribution of expenditures of households in the country. More specifically, the household income distributions can be linked to the household expenditure distributions using linear regressions to forecast the missing household expenditure data in the country. At 2106, the data related to the distributions of income and expenditures of households in the country is broken down into continuous percentage steps.

Going back to 2110, if data that is related to a distribution of income of households in the country is not available, the system determines if data is available that is related to the distribution of expenditures of households in the country, as in 2114. If data is available that is related to the distribution of expenditures of households in the country, the data related to the distribution of expenditures of households in the country is acquired and used to estimate the data related to a distribution of income of households in the country, as in 2116. For example, the data related to income of households in the country is acquired from the one or more data sources 130. In some examples, the data can be validated (e.g., see FIG. 18). The data related to expenditures of households in the country is used to estimate the data related to a distribution of income of households in the country. More specifically, the household expenditure distributions can be linked to the household income distributions using linear regressions to forecast the missing household income data in the country. At 2106, the data related to the distributions of income and expenditures of households in the country is broken down into continuous percentage steps.

Going back to 2114, if data is not available that is related to the distribution of expenditures of households in the country, one or more countries with similar characteristics are used to estimate the data related to both the distribution of income and expenditures of households in the country, as in 2118. For example, for countries with both missing household income data and missing household expenditure data, known household income data and/or household expenditure data from one or more countries with similar socioeconomic data can be used to estimate the missing household income data and/or the missing household expenditure data. At 2106, the data related to the distribution of income and expenditures of households in the country is broken down into continuous percentage steps.

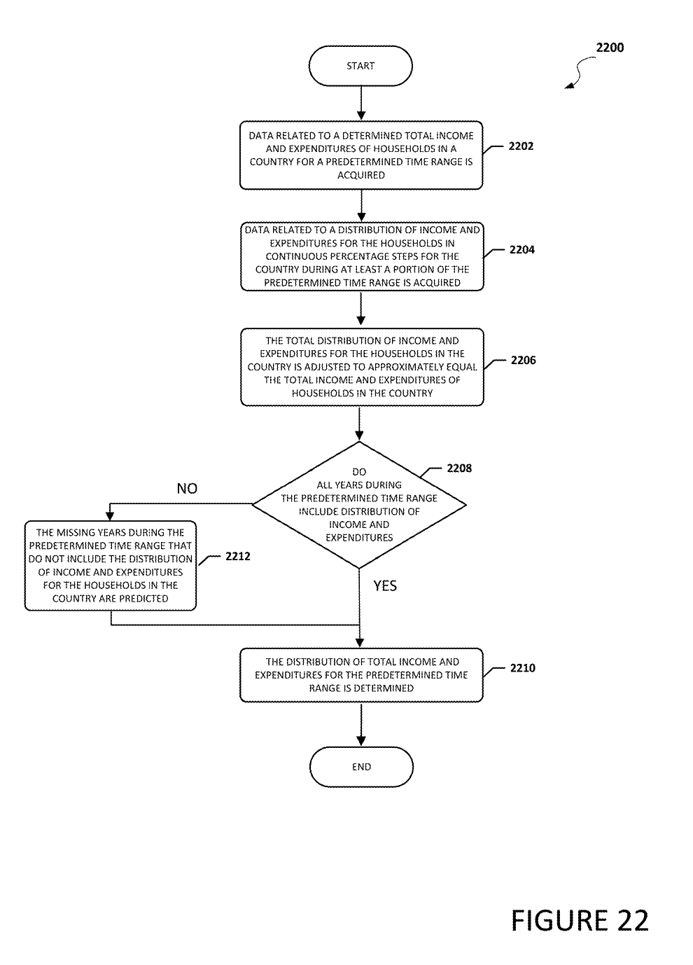

Turning to FIG. 22, FIG. 22 is an example flowchart illustrating possible operations of a flow 2200 that may be associated with potential operations to help enable determining and forecasting demographic expenditures on one or more categories of goods and/or services, in accordance with an embodiment of the present disclosure. Specifically, in some examples, one or more operations of flow 2200 may be performed by the total expenditure per demographic group engine 110, the income and expenditures per household engine 202, the distribution of income and expenditures engine 204, and/or the merge household income and expenditures with distribution of income and expenditures engine 206. At 2202, data related to the determined total income and expenditures of households in a country for a predetermined time range is acquired. For example, forecasts of household income and expenditure data for a total population of a country can be obtained from one or more data sources 130. In some examples, the data can be validated (e.g., see FIG. 6). Interpolation of the household income and the household expenditure distributions in the country can be used to predict income distributions and expenditure distributions during missing years of the predetermined time period and allow the predetermined time range to extend after the last data observations. More specifically, the predetermined time range can be ten prior years from the current year to fifty future years from the current year, from twenty prior years from the current year to ten future years from the current year, or some other predetermined time range, depending on user preference and system constraints.

At 2204, data related to a distribution of income and expenditures for the households in continuous percentage steps for the country during at least a portion of the predetermined time range is acquired. For example, using the distribution of income and expenditures of households in a country, a distribution of income and expenditures for the households in continuous percentage steps for the country during the predetermined time range can be determined. At 2206, the aggregate income and expenditures for the households in the country from the distributions are adjusted to approximately equal the total income and expenditures of household in the country. For example, the distributions of household income and expenditures are adjusted such that the sums of all the household income and expenditure from the corresponding distributions is equal to the total income and expenditure for the country. In some examples, the adjustment is a weighted adjustment not a linear adjustment because if the whole distribution or all the household income distributions and expenditure distributions were scaled up to match the total income and expenditure for the country, there would not be any poor people in the country because everybody was shifted up. Instead, extra expenditures are added to the households with higher income and expenditure such that the higher a household's income or expenditure, the more it is shifted up. The process can be iteratively repeated to shift the upper end more and more until the sum of all the household income and expenditure from the corresponding distributions is equal to the total income and expenditure for the country.

At 2208, the system determines if all years during the predetermined time range include distribution of income and expenditures. If all years during the predetermined time range include distribution of income and expenditures, the distribution of total income and expenditures for the predetermined time range is determined, as in 2210. If all years during the predetermined time range do not include the distribution of income and expenditures, the missing years during the predetermined time range that do not include the distribution of income and expenditures for the households in the country are predicted, as in 2212. For example, the missing years during the predetermined time range that do not include the distribution of income and expenditures for the households in the country can be predicted using interpolation.

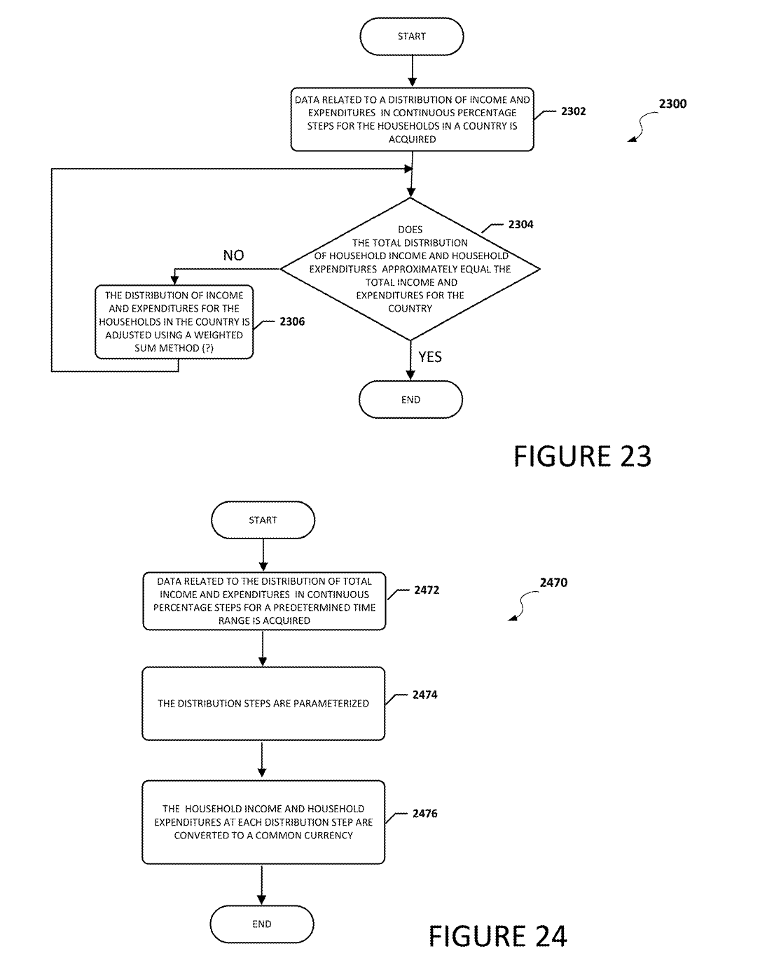

Turning to FIG. 23, FIG. 23 is an example flowchart illustrating possible operations of a flow 2300 that may be associated with potential operations to help enable determining and forecasting demographic expenditures on one or more categories of goods and/or services, in accordance with an embodiment of the present disclosure. Specifically, in some examples, one or more operations of flow 2300 may be performed by the total expenditure per demographic group engine 110, the income and expenditures per household engine 202, the distribution of income and expenditures engine 204, and/or the merge household income and expenditures with distribution of income and expenditures engine 206. At 2302, data related to a distribution of income and expenditures in continuous percentage steps for the households in a country is acquired. At 2304, the system determines if the total distribution of household income and household expenditures approximately equals the total income and expenditures for the country.

If the total distribution of household income and household expenditures does not approximately equal the total income and expenditures for the country, the distribution of income and expenditures for the households in the country is adjusted using a weighted sum method, as in 2306 and again, the system determines if the total distribution of household income and household expenditures approximately equals the total income and expenditures for the country, as in 2304. For example, extra expenditures are added to the households with higher income or expenditure such that the higher a household's income or expenditure, the more it is shifted up and the process is iteratively repeated until the sum of all the household income and household expenditures from the corresponding distributions approximately equals the total income and expenditures for the country and the process ends.

Turning to FIG. 24, FIG. 24 is an example flowchart illustrating possible operations of a flow 2400 that may be associated with potential operations to help enable determining and forecasting demographic expenditures on one or more categories of goods and/or services, in accordance with an embodiment of the present disclosure. Specifically, in some examples, one or more operations of flow 2400 may be performed by the total expenditure per demographic group engine 110, the income and expenditures per household engine 202, the distribution of income and expenditures engine 204, and/or the merge household income and expenditures with distribution of income and expenditures engine 206. At 2402, data related to a distribution of total income and expenditures in continuous percentage steps for a predetermined time range is acquired.

At 2404, the distribution steps are parameterized. For example, parameters are used that describe the distributions in a summarizing way and transform the distribution into another format to correlate the expenditures and the population. In one specific illustrative example, for each distribution, three parameters are estimated that describe the distribution in terms of the population and the expenditures on the left and right sides of an equation. More specifically, in a specific nonlimiting example, the expenditures equal the population minus theta (first parameter), times population to the power of gamma (second parameter), times one minus the population to the power of sigma (third parameter). The three parameters can be regression parameters used in a linear regression that describes the expenditures distribution. Other means may be used to correlate the expenditures and the population.

At 2406, the household income and household expenditures at each distribution step are converted to a common currency. For example, the household income and household expenditures at each distribution step are converted into monetary increments (e.g., one-dollar increments, one-euro increments, one-yen increments, etc.). For example, if the monetary increments are in one-dollar increments, "X" people have an income of zero to one dollar ($0-$1) per day, "Y" people have an income of one dollar to two dollars ($1-$2) per day, etc.

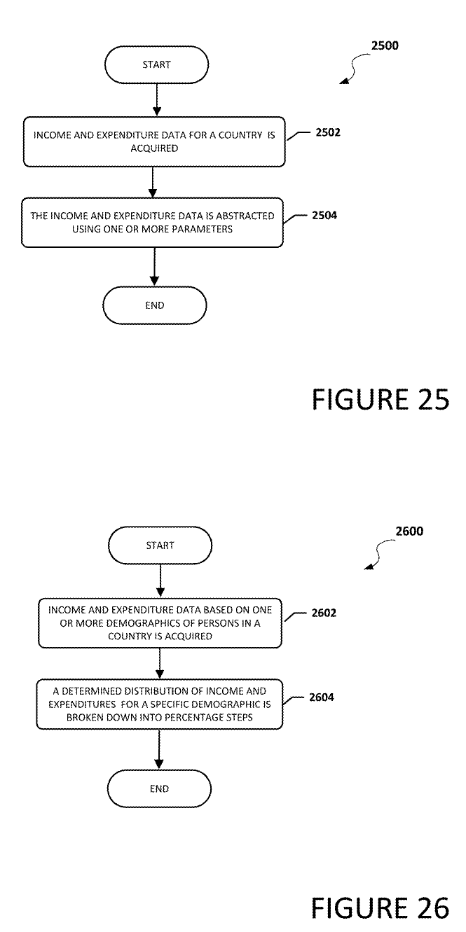

Turning to FIG. 25, FIG. 25 is an example flowchart illustrating possible operations of a flow 2500 that may be associated with potential operations to help enable determining and forecasting demographic expenditures on one or more categories of goods and/or services, in accordance with an embodiment of the present disclosure. Specifically, in some examples, one or more operations of flow 2500 may be performed by the total expenditure per demographic group engine 110, the income and expenditures per household engine 202, the distribution of income and expenditures engine 204, and/or the merge household income and expenditures with distribution of income and expenditures engine 206. At 2502, income and expenditure data for a country is acquired. For example, the one or more data sources 130 can be used to obtain income and expenditure data for a country. At 2504, the income and expenditure data is abstracted using one or more parameters. For example, one or more parameters that describe each household income and household expenditure distribution can be estimated. In a non-limiting example, a linear regression can be used to estimate three (or more) parameters that describe each household income and household expenditure distribution. The household income and household expenditure distributions are converted into monetary increments using the total household income and household expenditures for the country and the estimated one or more parameters that describe each household income and household expenditure distribution. In a specific illustrative example, for each distribution, three parameters are estimated that describe the distribution in terms of the population and the expenditures. More specifically, in a specific nonlimiting example, the expenditures equal the population minus theta (first parameter), times population to the power of gamma (second parameter), times one minus the population to the power of sigma (third parameter). The three parameters can be regression parameters used in a linear regression that describes the expenditures distribution. Other means may be used abstract the income and expenditure data. For example, other means may be used to correlate the expenditures and the population.

Turning to FIG. 26, FIG. 26 is an example flowchart illustrating possible operations of a flow 2600 that may be associated with potential operations to help enable determining and forecasting demographic expenditures on one or more categories of goods and/or services, in accordance with an embodiment of the present disclosure. Specifically, in some examples, one or more operations of flow 2600 may be performed by the total expenditure per demographic group engine 110, the income and expenditures per household engine 202, the distribution of income and expenditures engine 204, and/or the merge household income and expenditures with distribution of income and expenditures engine 206. At 2602, income and expenditure data based on one or more demographics of persons in a country is acquired. For example, based on surveys of persons in a country obtained from one or more data sources 130, income and expenditure data based on one or more demographics of persons in a country is acquired. In some examples, the data can be validated (e.g., see FIG. 18).

At 2604, a determined distribution of income and expenditures for a specific demographic is broken down into percentage steps. For example, using survey data from respondents in the country (e.g., from a data source 130), demographics can be associated with each respondent and each respondent can be assigned to an increment of the household income distributions and expenditure distributions according to the income and/or expenditures of each respondent. More specifically, in a non-limiting example, five percent (5%) increments of household income distributions and expenditure distributions can be identified (e.g., the poorest five percent (5%) of the population of the country have a maximum income of X, the poorest ten percent (10%) of the population of the country have a maximum income of Y, etc.) and each of the respondents to the survey can be assigned to a five percent (5%) increment of household income distributions and expenditure distributions. Each respondent in the survey has a weight that represents the number of people that each respondent stands for or represents. Based on the weights, the distributions for each demographic group can be based on the shares for different demographic groups obtained from surveys. For each demographic group, a distribution is obtained that corresponds to the proportion of the demographic group in each segment of the household income or expenditure distribution (e.g. young men represent thirty five percent (35%) of the poorest five percent (5%) in the country). The distribution can be applied to the national distribution to allow the distribution of income and expenditures for a specific demographic to be broken down into percentage steps.

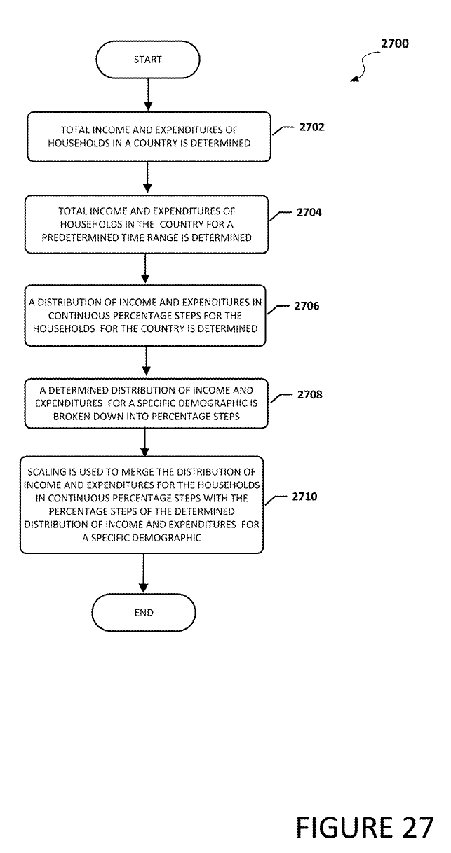

Turning to FIG. 27, FIG. 27 is an example flowchart illustrating possible operations of a flow 2700 that may be associated with potential operations to help enable determining and forecasting demographic expenditures on one or more categories of goods and/or services, in accordance with an embodiment of the present disclosure. Specifically, in some examples, one or more operations of flow 2700 may be performed by the total expenditure per demographic group engine 110, the income and expenditures per household engine 202, the distribution of income and expenditures engine 204, and/or the merge household income and expenditures with distribution of income and expenditures engine 206. At 2702, total income and expenditures of households in a country are determined. For example, household income and expenditure data for a total population of a country can be obtained from one or more data sources 130. In some examples, the data can be validated (e.g., see FIG. 18).

At 2704, the total income and expenditures of households in a country for a predetermined time range is determined. In an example, interpolation of the household income and the household expenditure distributions in the country can be used to predict income distributions and expenditure distributions during missing years of the predetermined time period and allow the predetermined time range to extend after the last data observations. More specifically, the predetermined time range can be ten prior years from the current year to fifty future years from the current year, from twenty prior years from the current year to ten future years from the current year, or some other predetermined time range, depending on user preference and system constraints.

At 2706, a distribution of income and expenditures in continuous percentage steps for the households in the country is determined. For example, using the distribution of income and expenditures of households in a country, a distribution of income and expenditures for the households in continuous percentage steps for the country during the predetermined time range can be determined.

At 2708, a determined distribution of income and expenditures for a specific demographic is broken down into percentage steps. For example, using survey data from respondents in the country (e.g., from a data source 130), demographics can be associated with each respondent and each respondent can be assigned to an increment of the household income distributions and expenditure distributions according to the income and/or expenditures of each respondent. More specifically, in a non-limiting example, five percent (5%) increments of household income distributions and expenditure distributions can be identified (e.g., the poorest five percent (5%) of the population of the country have a maximum income of "X", the poorest ten percent (10%) of the population of the country have a maximum income of "Y", etc.) and each of the respondents to the survey can be assigned to a five percent (5%) increment of household income distributions and expenditure distributions. Each respondent in the survey has a weight that represents the number of people that each respondent stands for or represents . The weights can be aggregated or summed such that for each group, one number of weights represents the number of people in the group. Based on the weights, the distributions for each demographic group can be based on the shares for different demographic groups obtained from surveys. For each demographic group, a distribution is obtained that corresponds to the proportion of the demographic group in each segment of the household income or expenditure distribution (e.g. young men represent thirty five percent (35%) of the poorest five percent (5%) in the country). The distribution can be applied to the national distribution to allow the distribution of income and expenditures for a specific demographic to be broken down into percentage step.

At 2710, scaling is used to merge the distribution of income and expenditures for the households in continuous percentage steps with the percentage steps of the determined distribution of income and expenditures for a specific demographic to create a distribution of income and expenditures for a specific demographic. For example, the scale distributions engine 502 can be configured to scale and merge the distribution of income and expenditures for the households in continuous percentage steps with the percentage steps of the determined distribution of income and expenditures for a specific demographic to create a distribution of income and expenditures for a specific demographic.

Adding up the combined information that gives the number of people per expenditures group for one or more demographics will not necessarily equal the total number of people per expenditures group. Adding the percentage steps might either match the population numbers, like the total number of people aged "X" (e.g., zero to ten (0-10)) or might match the correct number of people in the expenditures group (e.g., zero dollars to five dollars ($0-$5)) but, it might not match both. The scaling is for making sure the determined distribution of income and expenditures for a specific demographic matches the distribution of income and expenditures for the households.

The scaling is done iteratively until the distribution of income and expenditures for the households in continuous percentage steps is approximately equal to the percentage steps of the determined distribution of income and expenditures for a specific demographic. In a specific example, a matrix may be used where the row sums correspond to the numbers of people by expenditure group and the column sums correspond to the numbers of people by demographic group. Each cell in the matrix includes the number of people by the demographic group and expenditures group. The numbers are iteratively adjusted to make sure they add up to both the correct numbers of people by the expenditures group and the correct numbers of people by demographic group.

In a specific example, the scale distributions engine 502 is configured to scale the cells in the matrix to the total number of people per expenditures and to the total number of people per demographic group. In some examples, a multiplication factor is used to try and match the number of people by expenditure and demographic group to the total number of people per expenditures group and another multiplication factor is used to try and match them to the total number of people per demographic group. The scale distributions engine 502 can iteratively scale the distributions and with each iteration, the errors become smaller and smaller until the errors are negligible. Note that the numbers may not exactly match and a one percent (1%) error may be acceptable. In some examples after one-hundred (100) iterations, the scaling stops.

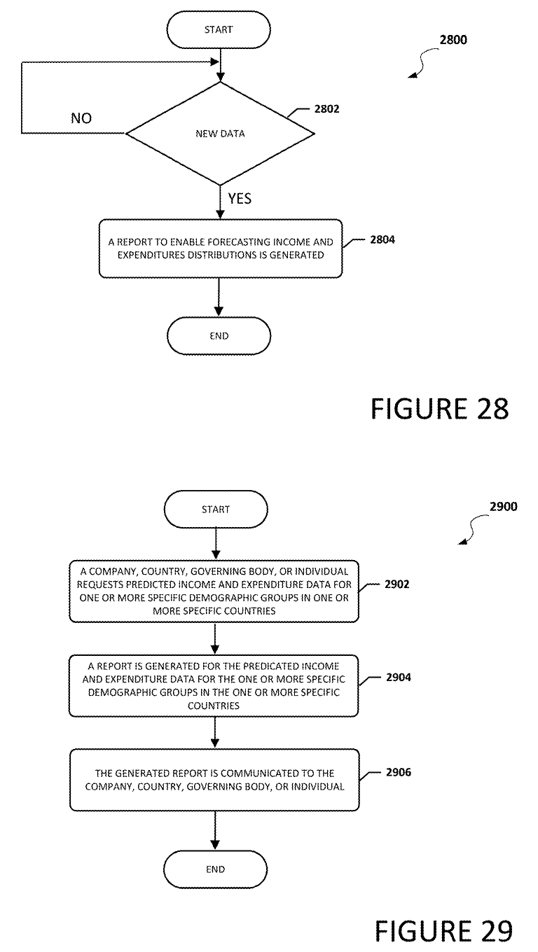

Turning to FIG. 28, FIG. 28 is an example flowchart illustrating possible operations of a flow 2800 that may be associated with potential operations to help enable determining and forecasting demographic expenditures on one or more categories of goods and/or services, in accordance with an embodiment of the present disclosure. Specifically, in some examples, one or more operations of flow 2800 may be performed by the total expenditure per demographic group engine 110, the income and expenditures per household engine 202, the distribution of income and expenditures engine 204, and/or the merge household income and expenditures with distribution of income and expenditures engine 206. At 2802, the system determines if new data is available. For example, the new data may be updated data from one or more data sources 130. If new data is available, then a report to enable determining and forecasting demographic expenditures on one or more categories of goods and/or services is generated, as in 12804. If new data is not available, the system returns to 2802 and again determines if new data is available. In some examples, the system can check for new day every hour, every day, every week, every month, every six months, etc.

Turning to FIG. 29, FIG. 29 is an example flowchart illustrating possible operations of a flow 2900 that may be associated with potential operations to help enable determining and forecasting demographic expenditures on one or more categories of goods and/or services, in accordance with an embodiment of the present disclosure. Specifically, in some examples, one or more operations of flow 2900 may be performed by the total expenditure per demographic group engine 110, the income and expenditures per household engine 202, the distribution of income and expenditures engine 204, and/or the merge household income and expenditures with distribution of income and expenditures engine 206. At 2902, a company, country, governing body, or individual requests predicted income and expenditure data for one or more specific demographic groups in one or more specific countries. For example, a retail company may request predicted income and expenditure data for women aged sixteen (16) to thirty (30) in India to try and estimate future cosmetic sales in India. In another example, a non- profit company that helps fight poverty may request income and expenditure data for people in rural areas of one or more countries to make poverty predictions for the rural areas of the one or more countries. In yet another example, a governing body may request predicted income and expenditure data for registered votes in a specific country to help create a policy platform. In still yet another example, a company may request predicted income and expenditure data for parents in the top twenty-five percent (twenty five percent (25%)) income bracket in China with children under five (5) years of age.

At 2904, a report is generated for the predicated income and expenditure data for the one or more specific demographic groups in the one or more specific countries. At 2906, the generated report is communicated to the company, country, governing body, or individual. In some examples, the report is electronically communicated to the company, country, governing body, or individual.

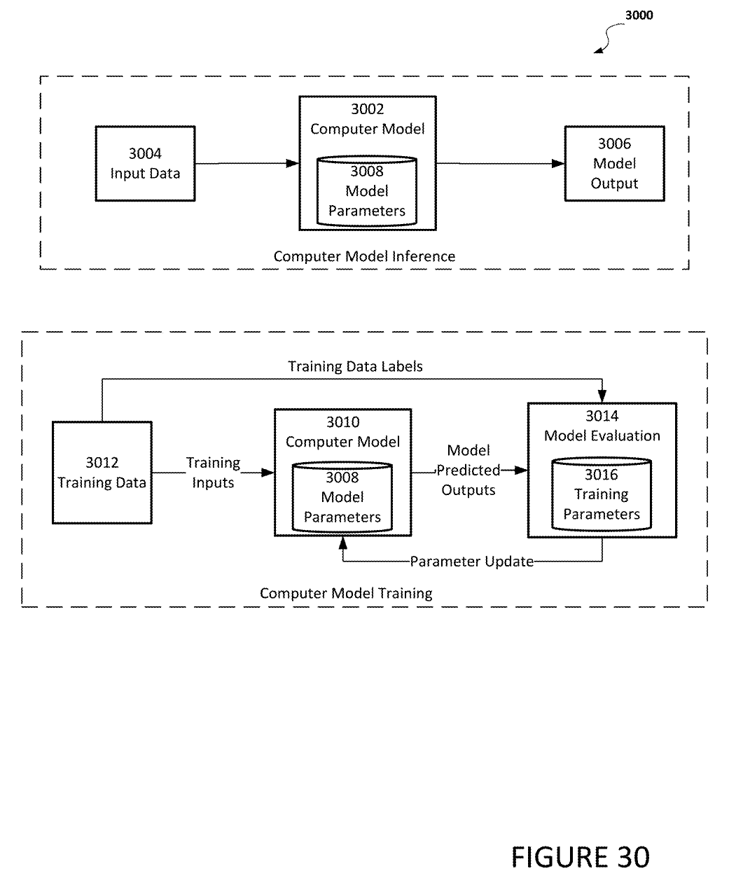

Turning to FIG. 30, FIG. 30 illustrates example computer model inference and computer model training 3000. Computer model inference refers to the application of a computer model 3002 to a set of input data 3004 to generate an output or model output 3006. The computer model 3002 determines the model output 3006 based on parameters of the model, also referred to as model parameters 3008. The parameters of the model may be determined based on a training process that finds an optimization of the model parameters 3008, typically using training data and desired outputs of the model for the respective training data as discussed below. The output (e.g., a country's total household income and expenditure) of the computer model 3002 may be referred to as an "inference" because it is a predictive value based on the input data 3004 and based on previous example data used in the model training.

The input data 3004 and the model output 3006 vary according to the particular use case. For example, to use socioeconomic data to forecast a country's total household income and expenditure, the input data 3004 may be data from one or more economic data sources 130 and the output or "inference" may be a forecast a country's total household income and expenditure. In another example, to use data to classify an expenditure into a classification of a good or service, the input data 3004 may be data from one or more data sources 130 and the output or "inference" may be the classification of an expenditure into a classification of a good or service. Such additional processing for inputs may themselves be learned representations of data, such that another computer model processes the input objects to generate an output that is used as the input data 3004 for the computer model 3002. Although not further discussed here, such further computer models may be independently or jointly trained with the computer model 3002. As noted above, the model output 3006 may depend on the particular application of the computer model 3002, for example, to determine and forecast demographic expenditures on one or more categories of goods and/or services.

The computer model 3002 includes various model parameters 3008, as noted above, that describe the characteristics and functions that generate the model output 3006 from the input data 3004. In particular, the model parameters 3008 may include a model structure, model weights, and a model execution environment. The model structure may include, for example, the particular type of computer model 3002 and its structure and organization. For example, the model structure may designate a neural network, which may be comprised of multiple layers, and the model parameters 3008 may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain "model parameters" of the model.

The model weights may represent the values with which the computer model 3002 processes the input data 3004 to the model output 3006. Each portion or layer of the computer model 3002 may have such weights. For example, weights may be used to determine values for processing inputs to determine outputs at a particular portion of a model. Stated another way, for example, model weights may describe how to combine or manipulate values of the input data 3004 or thresholds for determining activations as output for a model. As one example, a convolutional layer typically includes a set of convolutional "weights," also termed a convolutional kernel, to be applied to a set of inputs to that layer. These are subsequently combined, typically along with a "bias" parameter, and weights for other transformations to generate an output for the convolutional layer.

The model execution parameters represent parameters describing the execution conditions for the model. In particular, aspects of the model may be implemented on various types of hardware or circuitry for executing the computer model 3002. For example, portions of the model may be implemented in various types of circuitry, such as general-purpose circuity (e.g., a general CPU), circuity specialized for certain functions (e.g., a GPU or programmable Multiply-and-Accumulate circuit) or circuitry specially designed for the particular computer model application. In some configurations, different portions of the computer model 3002 may be implemented on different types of circuitries. As discussed below, training of the model may include optimizing the types of hardware used for certain aspects of the computer model 3002 (e.g., co-trained), or may be determined after other parameters for the computer model 3002 are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or "train" the values of the model parameters 3008 for the computer model 3010. During training, the model parameters 3008 are optimized to "learn" values of the model parameters (such as individual weights, activation values, model execution environment, etc.), that improve the model parameters 3008 based on an optimization function that seeks to improve a cost function (also sometimes termed a loss function). Before training, the computer model 3010 has model parameters 3008 that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 3012 includes a data set to be used for training the computer model 3010. The data set varies according to the particular application and purpose of the computer model 3010. In supervised learning tasks, the training data 3012 typically includes a set of training data labels that describe the training data 3012 and the desired output of the model relative to the training data 3012. For example, for an object classification task, the training data 3012 may include individual images in which individual portions, regions or pixels in the image are labeled with the classification of the object. For this task, the training data 3012 may include a training data image depicting a dog and a person and training data labels that label the regions of the image that include the dog and the person, such that the computer model 3010 is intended to learn to also label the same portions of that image as a dog and a person, respectively. In another example, the training data 3012 may include various total household income and expenditures of a country such that the computer model 3010 is intended to learn to forecast total household income and expenditures. In yet another example, the training data may include various expenditures that have been assigned to a category of goods or services such that the computer model 3010 is intended to learn to assign an expenditure of a demographic group to a category of goods or services.

To train the computer model 3010, a training module (not shown) applies the training inputs to the computer model 3010 to determine the outputs predicted by the model for the given training inputs. The training module, though not shown, is a computing module used for performing the training of the computer model 3010 by executing the computer model 3010 according to its inputs and outputs given the model's parameters and modifying the model parameters based on the results. The training module may apply the actual execution environment of the computer model 3010, or may simulate the results of the execution environment, for example to estimate the performance, runtime, memory, or circuit area (e.g., if specialized hardware is used) of the computer model 3010. The training module, along with the training data 3012 and model evaluation, may be instantiated in software and/or hardware by one or more processing devices. In various examples, the training process may also be performed by multiple computing systems in conjunction with one another, such as distributed/cloud computing systems. In some examples the training of the computer module 3010 may be different if the computer model 3010 is a large language model (LLM). A LLM is used for language-based tasks, whereas the general Al model can be used for a variety of other tasks.

After processing the training inputs according to the current model parameters for the computer model 3010, the model's predicted outputs are evaluated and the computer model 3010 is evaluated with respect to the cost function and optimized using an optimization function of the training model. Depending on the optimization function, particular training process and training parameters 3016 after the model evaluation are updated to improve the optimization function of the computer model 3010. In supervised training (i.e., training data labels are available), the cost function may evaluate the model's predicted outputs relative to the training data labels and to evaluate the relative cost or loss of the prediction relative to the "known" labels for the data. This provides a measure of the frequency of correct predictions by the computer model 3010 and may be measured in various ways, such as the precision (frequency of false positives) and recall (frequency of false negatives). The cost function in some circumstances may also evaluate other characteristics of the model, for example the model complexity, processing speed, memory requirements, physical circuit characteristics (e.g., power requirements, circuit throughput) and other characteristics of the computer model 3010 structure and execution environment (e.g., to evaluate or modify these model parameters).

After determining results of the cost function, the optimization function determines a modification of the model parameters to improve the cost function for the training data 3012. Many such optimization functions are known to one skilled on the art. Many such approaches differentiate the cost function with respect to the parameters of the model and determine modifications to the model parameters that thus improves the cost function. The parameters for the optimization function, including algorithms for modifying the model parameters are the training parameters 3016 for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data 3012 is batched and the parameter updates are iteratively applied to batches of the training data 3012. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data 3012 available or the incremental improvements in model parameters are below a threshold (e.g., additional training data 3012 no longer continues to improve the model parameters). Additional training parameters 3016 may describe the batch size for the training data 3012, a portion of training data 3012 to use as validation data, the step size of parameter updates, a learning rate of the model, and so forth. Additional techniques may also be used to determine global optimums or address nondifferentiable model parameter spaces.

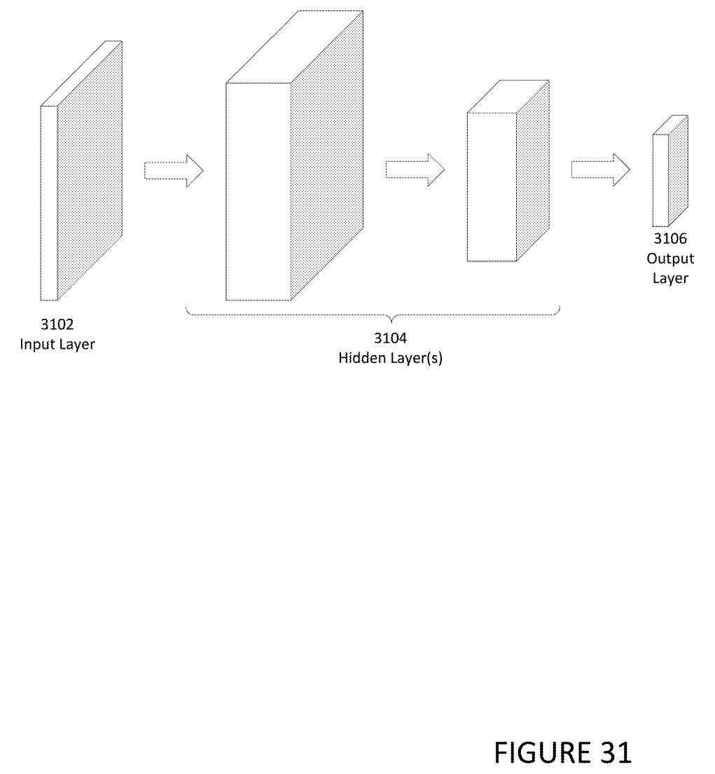

Turning to FIG. 31, FIG. 31 illustrates an example neural network architecture. In general, a neural network includes an input layer 3102, one or more hidden layers 3104, and an output layer 3106. The values for data in each layer of the network are generally determined based on one or more prior layers of the network. Each layer of a network generates a set of values, termed "activations" that represent the output values of that layer of a network and may be the input to the next layer of the network. For the input layer 3102, the activations are typically the values of the input data, although the input layer 3102 may represent input data as modified through one or more transformations to generate representations of the input data. For example, in recommendation systems, interactions between users and objects may be represented as a sparse matrix. Individual users or objects may then be represented as an input layer 3102 as a transformation of the data in the sparse matrix relevant to that user or object. The neural network may also receive the output of another computer model (or several), as its input layer 3102, such that the input layer 3102 of the neural network shown in FIG. 31 is the output of another computer model. Accordingly, each layer may receive a set of inputs, also termed "input activations," representing activations of one or more prior layers of the network and generate a set of outputs, also termed "output activations" representing the activation of that layer of the network. Stated another way, one layer's output activations become the input activations of another layer of the network, except for the final output layer of 3106 of the network.

Each layer of the neural network typically represents its output activations (i.e., also termed its outputs) in a matrix, which may be 1, 2, 3, or n-dimensional according to the particular structure of the network. As shown in FIG. 31, the dimensionality of each layer may differ according to the design of each layer. The dimensionality of the output layer 3106 depends on the characteristics of the prediction made by the model. For example, a computer model for multi-object classification may generate an output layer 3106 having a one-dimensional array in which each position in the array represents the likelihood of a different classification for the input layer 3102. In another example for classification of portions of an image, the input layer 3102 may be an image having a resolution, such as 512x512, and the output layer may be a 512x512xn matrix in which the output layer 3106 provides n classification predictions for each of the input pixels, such that the corresponding position of each pixel in the input layer 3102 in the output layer 3106 is an n-dimensional array corresponding to the classification predictions for that pixel.

The hidden layers 3104 provide output activations that variously characterize the input layer 3102 in various ways that assist in effectively generating the output layer 3106. The hidden layers thus may be considered to provide additional features or characteristics of the input layer 3102. Though two hidden layers are shown in FIG. 31, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully-connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer is typically termed a weight. For example, in some layers, the function is a multiplication of each input with a respective weight to determine the activations for that layer.

For a neural network, the parameters for the model as a whole thus may include the parameters for each of the individual layers and in large-scale networks can include hundreds of thousands, millions, or more of different parameters.

As one example for training a neural network, the cost function is evaluated at the output layer 3106. To determine modifications of the parameters for each layer, the parameters of each prior layer may be evaluated to determine respective modifications. In one example, the cost function (or "error") is backpropagated such that the parameters are evaluated by the optimization algorithm for each layer in sequence, until the input layer 3102 is reached.

In the description, various aspects of the illustrative implementations are described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For the purposes of the present disclosure, the phrase "A and/or B" means (A), (B), or (A and B). For the purposes of the present disclosure, the phrase "A, B, and/or C" means (A), (B), (C), (A and B), (A and C), (B and C), or (A, B, and C). Reference to "one embodiment" or "an embodiment" in the present disclosure means that a particular feature, structure, or characteristic described in connection with the embodiment is included in at least one embodiment. The appearances of the phrase "in one embodiment" or "in an embodiment" are not necessarily all referring to the same embodiment. Reference to "one example" or "an example" in the present disclosure means that a particular feature, structure, or characteristic described in connection with the embodiment is included in at least one example or embodiment. The appearances of the phrase "in one example" or "in an example" are not necessarily all referring to the same examples or embodiments. The terms "substantially," "close," "approximately," "near," and "about," generally refer to being within +/- 20% of a target value based on the context of a particular value as described herein or as known in the art.

As used herein, the term "when" may be used to indicate the temporal nature of an event. For example, the phrase "event 'A' occurs when event 'B' occurs" is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Substantial flexibility is provided by the system, apparatus, and a method to enable determining and forecasting demographic expenditures on one or more categories of goods and/or services in that any suitable arrangements, chronologies, configurations, and timing mechanisms may be provided without departing from the teachings of the present disclosure.

Note that embodiments of the total expenditure per demographic group engine 110, the expenditure on goods and/or services engine 112, the distribution of expenditure per demographic group on goods and/or services engine 114, the income and expenditures per household engine 202, the distribution of income and expenditures engine 204, the merge income and expenditures with distribution of income and expenditures engine 206, the predict missing income and/or expenditures engine 302, the predict missing years engine 304, the percentage breakdown engine 306, the data correction engine 308, the aggregate national distribution engine 402, the demographics distribution engine 404, the scale distributions engine 502, the report generation engine 504, the assign expenditures to category engine 602, the predict missing category engine 604, the predict missing years engine 606, the percentage breakdown engine 608, the data correction engine 610, the report generation engine 612, the scale distributions engine 702, and/or the report generation engine 704 may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces, may include physical ports (e.g., Ethernet, USB, HDMI, etc.), interfaces for wired and wireless internal subsystems, and the like. Similarly, each of the network nodes, the total expenditure per demographic group engine 110, the expenditure on goods and/or services engine 112, the distribution of expenditure per demographic group on goods and/or services engine 114, the income and expenditures per household engine 202, the distribution of income and expenditures engine 204, the merge income and expenditures with distribution of income and expenditures engine 206, the predict missing income and/or expenditures engine 302, the predict missing years engine 304, the percentage breakdown engine 306, the data correction engine 308, the aggregate national distribution engine 402, the demographics distribution engine 404, the scale distributions engine 502, the report generation engine 504, the assign expenditures to category engine 602, the predict missing category engine 604, the predict missing years engine 606, the percentage breakdown engine 608, the data correction engine 610, the report generation engine 612, the scale distributions engine 702, the report generation engine 704, etc. of the system can also include suitable interfaces for receiving, transmitting, and/or otherwise communicating data or information in a network environment.

The total expenditure per demographic group engine 110, the expenditure on goods and/or services engine 112, the distribution of expenditure per demographic group on goods and/or services engine 114, the income and expenditures per household engine 202, the distribution of income and expenditures engine 204, the merge income and expenditures with distribution of income and expenditures engine 206, the predict missing income and/or expenditures engine 302, the predict missing years engine 304, the percentage breakdown engine 306, the data correction engine 308, the aggregate national distribution engine 402, the demographics distribution engine 404, the scale distributions engine 502, the report generation engine 504, the assign expenditures to category engine 602, the predict missing category engine 604, the predict missing years engine 606, the percentage breakdown engine 608, the data correction engine 610, the report generation engine 612, the scale distributions engine 702, and/or the report generation engine 704 and other associated or integrated components can include one or more memory elements for storing information to be used in achieving operations associated with enabling determining and forecasting demographic expenditures on one or more categories of goods and/or services, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the system 100 could be provided in any database, register, table, cache, queue, control list, or storage structure, based on particular needs and implementations, all of which could be referenced in any suitable timeframe. Any of the memory or storage options discussed herein should be construed as being encompassed within the broad term 'memory element' as used herein in this Specification.

In example embodiments, the operations for enabling determining and forecasting demographic expenditures on one or more categories of goods and/or services, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements can store data used for the operations described herein. This includes the memory elements being able to store software, logic, code, or processor instructions that are executed to carry out enabling determining and forecasting demographic expenditures on one or more categories of goods and/or services described in this Specification. Regarding a physical implementation of the total expenditure per demographic group engine 110, the expenditure on goods and/or services engine 112, the distribution of expenditure per demographic group on goods and/or services engine 114, the income and expenditures per household engine 202, the distribution of income and expenditures engine 204, the merge income and expenditures with distribution of income and expenditures engine 206, the predict missing income and/or expenditures engine 302, the predict missing years engine 304, the percentage breakdown engine 306, the data correction engine 308, the aggregate national distribution engine 402, the demographics distribution engine 404, the scale distributions engine 502, the report generation engine 504, the assign expenditures to category engine 602, the predict missing category engine 604, the predict missing years engine 606, the percentage breakdown engine 608, the data correction engine 610, the report generation engine 612, the scale distributions engine 702, the report generation engine 704 and/or and their associated components, any suitable permutation may be applied based on particular needs and requirements.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the system, apparatus, and a method to enable determining and forecasting demographic expenditures on one or more categories of goods and/or services and their teachings are readily scalable and can accommodate a large number of components, as well as more complicated/sophisticated arrangements and configurations. Accordingly, the examples provided should not limit the scope or inhibit the broad teachings of the system, apparatus, and method to enable determining and forecasting demographic expenditures on one or more categories of goods and/or services and as potentially applied to a myriad of other architectures.

It is also important to note that the operations in the preceding flow diagrams (i.e., FIGS. 9-29) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system and method have been illustrated with reference to particular elements and operations, these elements and operations may be replaced by any suitable architecture, protocols, and/or processes that achieve the intended functionality of the system and method.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words "means for" or "step for" are specifically used in the particular claims; and (b) does not intend, by any statement in the specification, to limit this disclosure in any way that is not otherwise reflected in the appended claims.

What is claimed is:

1. A method, comprising:collecting household income and expenditures data for a country from one or more data sources;breaking down the household income and expenditures data into first percentage steps;collecting distribution demographic data for the country;breaking down the distribution demographic data into second percentage steps;merging the household income and expenditures data in the first percentage steps with the distribution demographic data in the second percentage steps to determine a total expenditure of a specific demographic group in the country;determining a share of total expenditures for one or more categories of goods and/or services for the country;allocating at least a portion of the total expenditure of the specific demographic group to the one or more categories of goods and/or services based on the determined share; andgenerating a report determining and forecasting demographic expenditures on the one or more categories of goods and/or services for the country.

2. The method of claim 1, further comprising:determining a period of time;extending the household income and expenditures data for the country for each year in the period of time; andextending the distribution demographic data for the country for each year in the period of time.

3. The method of claim 2, wherein missing income data and/or missing expenditure data for the period of time is predicted using a gross domestic product (GDP) growth rate for the country.

4. The method of claim 1, wherein breaking down the household income and expenditures data into first percentage steps comprises breaking down the household income and expenditures data into one percent increments.

5. The method of claim 1, wherein breaking down the distribution demographic data into second percentage steps comprises breaking down the distribution demographic data into five percent increments.

6. The method of claim 1, wherein determining the share of total expenditures for the one or more categories of goods and/or services comprises using classification of individual consumption by purpose (COICOP) data.

7. The method of claim 1, wherein determining the share of total expenditures for the one or more categories of goods and/or services comprises using household survey data.

8. The method of claim 1, wherein merging the household income and expenditures data with the distribution demographic data comprises scaling the distribution demographic data to match the household income and expenditures data using iterative proportional fitting.

9. A system, comprising:memory;at least one processor; anda total expenditure per demographic group engine configured to:obtain household income and expenditures data for a country from one or more data sources;break down the household income and expenditures data into first percentage steps;obtain distribution demographic data for the country;break down the distribution demographic data into second percentage steps; andmerge the household income and expenditures data in the first percentage steps with the distribution demographic data in the second percentage steps to determine a total expenditure of a specific demographic group in the country;an expenditure on goods and/or services engine configured to:determine a share of total expenditures for one or more categories of goods and/or services for the country; andallocate at least a portion of the total expenditure of the specific demographic group to the one or more categories of goods and/or services; anda distribution of expenditure per demographic group on goods and/or services engine configured to:determine a category or subcategory expenditure of the specific demographic group in the country based on the total expenditure of the specific demographic group and the share of total expenditures for the one or more categories of goods and/or services.

10. The system of claim 9, wherein the expenditure on goods and/or services engine is configured to determine the share of total expenditures using classification of individual consumption by purpose (COICOP) data.

11. The system of claim 10, wherein the expenditure on goods and/or services engine is configured to allocate the portion of the total expenditure to Level 1 categories, Level 2 subcategories, and Level 3 subcategories of the COICOP classification.

12. The system of claim 9, wherein the distribution of expenditure per demographic group on goods and/or services engine is configured to perform iterative proportional fitting to ensure subcategory expenditures for the specific demographic group add up to the specific demographic group's expenditure on a parent category.

13. The system of claim 9, further comprising: a report generation engine configured to generate a report forecasting demographic expenditures on the one or more categories of goods and/or services for the country.

14. A method comprising: collecting household income and expenditures data for a country; determining a distribution of income and expenditures for households in the country in continuous percentage steps; parameterizing the distribution of income and expenditures using one or more parameters; converting the distribution of income and expenditures to a common currency; collecting survey data including demographics of respondents from the country; determining a distribution of income and expenditures for a specific demographic group based on the survey data; merging the distribution of income and expenditures for the households with the distribution of income and expenditures for the specific demographic group to create a distribution of income and expenditures for the specific demographic group; determining a share of total expenditures for one or more categories of goods and/or services for the country; and forecasting expenditure of the specific demographic group on the one or more categories of goods and/or services.

15. The method of claim 14, wherein parameterizing the distribution of income and expenditures comprises using linear regression to estimate three parameters that describe each income distribution and expenditure distribution for the country.

16. The method of claim 14, wherein merging the distribution of income and expenditures for the households with the distribution of income and expenditures for the specific demographic group comprises iteratively scaling until the distribution of income and expenditures for the households is approximately equal to the distribution of income and expenditures for the specific demographic group.

17. The method of claim 14, further comprising:adjusting distributions of household income and expenditures such that a sum of household income and expenditures from the distribution equals a total income and expenditure for the country using a weighted adjustment.

18. The method of claim 14, wherein determining the share of total expenditures for the one or more categories of goods and/or services comprises:collecting expenditure shares data from one or more of national accounts data, Consumer Price Index (CPI) weights, household expenditure data, and national household expenditure survey results; andusing a machine learning model to predict expenditure shares for categories where data is missing.

19. The method of claim 14, wherein the expenditure on goods and/or services engine is configured to determine the share of total expenditures at least partially using classification of individual consumption by purpose (COICOP) data.

20. The method of claim 14, wherein determining the share of total expenditures for the one or more categories of goods and/or services comprises using household survey data.
